(19) United States
(12) Patent Application Publication
(10) Pub. No.: US 2008/0241514 A1
(43) Pub. Date: Oct. 2, 2008

(54) Method for forming plating film, polymer member, and method for producing the same

(75) Inventors: Atsushi YUSA, Ibaraki-shi (JP); Tetsuya ANO, Ibaraki-shi (JP); Yoshiyuki NOMURA, Ibaraki-shi (JP); Tetsuo MIZUMURA, Ibaraki-shi (JP)

Correspondence Address: OLIFF & BERRIDGE, PLC, P.O. BOX 320850, ALEXANDRIA, VA, 22320-4850, US

(73) Assignee: HITACHI MAXELL, LTD., Ibaraki-shi (JP)

(21) Appl. No.: 12/078,626

(22) Filed: Apr. 2, 2008

(30) Foreign Application Priority Data
Apr. 2, 2007 (JP) 2007-096857

(51) Int. Cl. B32B 5/16; B29C 70/86; B05D 3/10; B05D 7/02

(52) U.S. Cl. 428/328; 428/323; 264/82; 427/304

(57) ABSTRACT

A method for forming an electroless plating film on surfaces of various types of polymer members is provided, the electroless plating film being formed economically with high adhesion strength. The method for forming the plating film on the polymer member comprises preparing a polymer member including a metal substance, in an internal portion of the polymer member, which serves as plating catalyst cores, the polymer member having a surface on which the plating film is to be formed and which is inactive to the electroless plating solution at an atmospheric pressure; and forming the plating film on the surface of the polymer member by bringing the polymer member in contact with the electroless plating solution to which the pressurized carbon dioxide has been added.

### CROSS-REFERENCES TO RELATED APPLICATIONS

This application claims priority to a Japanese application No. 2007-096857 filed Apr. 2, 2007, the entire disclosures of which is hereby incorporated by reference.

### BACKGROUND OF THE INVENTION

1. Field of the Invention

The present invention relates to a method for forming a plating film on a polymer member, and the polymer member produced by the method. In particular, the present invention relates to a method for forming a plating film on a polymer member, suitable for the electroless plating method, and the polymer member produced by the method.

2. Description of the Related Art

Conventionally, the electroless plating method is known as a method for forming economically a metal film on a surface of a polymer member (polymer molded article).

However, the electroless plating method requires a pretreatment to roughen the surface of the polymer member before the electroless plating, in order to secure the adhesion performance of the plating film to the polymer member. In the pretreatment, an oxidizing agent such as hexavalent chromic acid or permanganic acid is used to etch the surface of the polymer member. Less usage of these oxidizing agents is required recently.

Materials of the polymer which can be immersed in the etching solution, i.e., materials of the polymer to which the electroless plating can be applied, limited to the ABS resin. The ABS resin contains a butadiene rubber component, and this component is selectively eroded by the etching solution. Accordingly, the irregularities are formed on the surface of the polymer member made of the ABS resin. On the contrary, any polymer material other than the ABS resin includes a small amount of the component which is to be selectively oxidized by the etching solution. Therefore, the irregularities are hardly formed on the surface of the polymer member made of the any polymer material other then the ABS resin.

Therefore, in the case of the polymer material other than the ABS resin, for example, in the case of the polycarbonate resin or the like, a material as plating grade is commercially available by a material mixed with the ABS resin, the elastomer or the like which is going to be etched selectively. However, in the case of the mixed material, it is inevitable that the physical properties are deteriorated as compared with those of the original or main material. For example, heat resistance of the mixed material is lowered as compared with the heat resistance of the original or main material. As a result, it has been difficult to apply such the mixed material to any way of use of the molded article in which the heat resistance is required.

On the other hand, a technique has been suggested hitherto for the pretreatment of the plating, in which pressurized carbon dioxide such as supercritical carbon dioxide is used to modify a surface of a polymer member. In this surface modification method based on the use of the pressurized carbon dioxide, a functional material is dissolved in the pressurized carbon dioxide, and the pressurized carbon dioxide, in which the functional material has been dissolved, is allowed to make contact with the polymer member. The polymer member is impregnated with the functional material together with the pressurized carbon dioxide. Accordingly, the surface of the polymer member is allowed to have the highly advanced function or high performance by the impregnated functional material. Physical properties of the surface of the polymer member are modified.

In particular, the present inventors already disclosed a modifying method, in which a surface modification treatment is performed simultaneously with the injection molding by using pressurized carbon dioxide, and thus in which a surface of a polymer molded article is allowed to have a highly advanced function property or a high performance property. See, for example, Japanese Patent No. 3696878.

Japanese Patent No. 3696878 discloses the following surface modification method.

In the general injection molding process, the resin is plasticized and weighed in a heating cylinder (plasticizing cylinder) of an injection molding machine, and then the weighed resin is injected successively.

On the contrary, in the injection molding process described in Japanese Patent No. 3696878, when the resin is plasticized and weighed, and before the injection of the weighed resin, the screw in the heating cylinder is subjected to the suck back so that the screw is moved backwardly. Accordingly, the pressure of the melted resin contained in the heating cylinder is lowered as compared with the pressure in the brought about when the resin is plasticized and weighed, and the melted resin is in the negative pressure state or in the low pressure state. Subsequently, both of the pressurized carbon dioxide in the supercritical state and the functional organic material dissolved therein, for example, the functional organic material such as the metal complex is introduced into the heating cylinder in the negative pressure state. Upon the introduction, it is appropriate that both of the pressurized carbon dioxide and the functional organic material are introduced into a frontward portion of the screw, which is corresponding to a front portion of the screw in the heating cylinder (hereinafter referred to as a flow front portion). In accordance with this operation, both of the pressurized carbon dioxide and the functional material are permeated into the melted resin disposed at the frontward portion of the screw.

Subsequently, the weight melted resin is injected from the heating cylinder, and the melted resin is charged into the mold. The melted resin disposed at the flow front portion, into which the functional material is permeated, is firstly injected into the mold, and then the melted resin, which is disposed at the backward portion of the heating cylinder, i.e., the melted resin into which the functional material is scarcely permeated is injected into the mold. The melted resin, into which the functional material is permeated and which is disposed at the frontward portion of the screw, is injected into the mold while being pulled by the surface of the mold. Therefore, the melted resin impregnated with the functional material is spread while maintaining a state in which the injected resin keeps contact with the surface of the mold. Therefore, the injected resin, into which the functional material is permeated and which is disposed at the frontward portion of the screw, forms the surface layer (skin layer) of the polymer molded article. The flowing phenomenon of the injected resin in the mold is called “fountain flow phenomenon (fountain effect)”.

Therefore, by the surface modification method described in Japanese Patent No. 3696878, the polymer molded article is manufactured which is impregnated with the functional material and which has the modified surface.

When the metal complex or the like, which serves as the plating catalyst, is used as the functional material in the method for modifying the surface described in Japanese Patent No. 3696878, the polymer molded article is obtained in which the surface of the article is impregnated with the plating catalyst. That is, it is possible to obtain the injection molding article on which the electroless plating can be performed by means of the conventional plating process, without requiring the surface roughening with the etching solution.

On the other hand, a method was disclosed, in which the supercritical carbon dioxide is added to an electroless plating solution, which is distinct from the conventional printing process in which the plating treatment is performed at the atmospheric pressure (hereinafter referred to as “first conventional plating method”). See, for example, Japanese Patent No. 3571627 and “Surface Technology”, Vol. 56, No. 2, p. 83 (2005). These documents disclose the electroless plating method in which the supercritical carbon dioxide is compatibly dissolved in the electroless plating solution by using a surfactant. The surfactant agitates to form an emulsion or an emulsion state and the plating reaction is caused in the emulsion. Hereinafter this method is referred to as “second conventional plating method”.

In the case of the electroless plating or in the case of the electroplating, usually, the hydrogen gas is produced during the plating reaction. The hydrogen gas stays on the surface of the plating object, and the hydrogen gas is volatilized after the plating reaction. As a result, pin holes are formed by the hydrogen gas in the formed plating film.

On the contrary, in the second conventional electroless plating method disclosed in the documents described above, the supercritical carbon dioxide is added to the electroless plating solution. Therefore, the hydrogen gas is dissolved in the supercritical carbon dioxide. Accordingly, the hydrogen gas can be removed from the plating film during the plating reaction. As a result, it is possible to obtain the electroless plating film in which the pin holes are hardly formed and the hardness of the film is high. The second conventional plating method obtains the effect as described above by adding the supercritical carbon dioxide to the electroless plating solution.

As described above, the first conventional plating method requires the pretreatment in order to roughen the surface and is necessary to use in the pretreatment the etching solution which is required to reduction of use recently. Further, in the first conventional plating method, the selectivity of the polymer material is narrow.

When the polymer member is impregnated with the metallic fine particles which serve as the plating catalyst, by using the surface modification method described in Japanese Patent No. 3696878, the plating treatment can be performed without performing the pretreatment based on the etching, even in the case of the first conventional plating method.

However, when the method for modifying the surface described in Japanese Patent No. 3696878 is used as the pretreatment of the first conventional plating method and the plating film is formed, the metallic fine particles are present on the outermost surface of the polymer member and the particles on the outermost surface contribute as the catalyst cores of the electroless plating. Therefore, the plating film is formed in a state of being placed on the outermost surface of the polymer member. In addition, the surface of the polymer member is not roughened and the physical anchoring effect of the plating film is not obtained. As a result, it is difficult to obtain the strong adhesion performance between the plating film and the molded article.

The present inventors have confirmed the following facts by means of the special and unique studies. That is, the metallic fine particles are also present at portions deeper than the outermost surface of the polymer member obtained by the method for modifying the surface described in Japanese Patent No. 3696878. Further, the plating film does not grow from the metallic fine particles disposed at portions deeper than the outermost surface of the polymer member by means of the first conventional plating method, even though the polymer member in which the surface has been modified by the particles. In other words, assuming that the area, in which the catalyst cores are present, is defined as “surface internal portion”, only the metallic fine particles, which are not only included in the surface internal portion but also exist at the outermost surface of the polymer member, can contribute as the catalyst cores of the electroless plating in the case of the method based on the combination as described above. The metallic fine particles, which exist at the portions deeper than the outermost surface of the polymer member, do not function as the catalyst cores. In addition, the metallic fine particles at the portions deeper than the outermost surface are just the excessive catalyst cores and uneconomic.

### SUMMARY OF THE INVENTION

The present invention has been made in order to solve the problem as described above. An object of the present invention is to provide a method for economically forming an electroless plating film with high adhesion strength on a surface of a polymer member.

According to a first aspect of the present invention, there is provided a method for forming a plating film on a polymer member by using an electroless plating solution, the method comprising preparing a polymer member containing a metal substance, in an internal portion of the polymer member, which serves as plating catalyst cores, the polymer member having an inactive surface which is inactive to the electroless plating solution at an atmospheric pressure; adding pressurized carbon dioxide to the electroless plating solution; and forming the plating film on the inactive surface of the polymer member by bringing the polymer member in contact with the electroless plating solution to which the pressurized carbon dioxide has been added.

According to a second aspect of the present invention, there is provided a method for forming a plating film on a polymer member by using an electroless plating solution, the method comprising preparing a polymer member having a surface outermost portion and an inside portion, and a metal substance, which is impregnated in the surface outermost portion and the inside portion, the metal substance serving as plating catalyst cores and being contained higher in the inside portion than in the surface outermost portion; adding pressurized carbon dioxide to the electroless plating solution; and forming the plating film on the surface outermost portion of the polymer member by bringing the polymer member in contact with the electroless plating solution to which the pressurized carbon dioxide has been added.

The term “pressurized carbon dioxide” referred to in this specification means carbon dioxide which is pressurized. The term “pressurized carbon dioxide” referred to herein includes not only carbon dioxide in the supercritical state but also pressurized carbon dioxide in the liquid state and pressurized carbon dioxide in the gaseous state. Therefore, the “pressure of pressurized carbon dioxide” includes not only the pressure larger than the pressure at the critical point of the carbon dioxide (in the pressure of the supercritical state) but also the pressure which is lower than the pressure at the critical point.

More specifically, in the present invention, in order that the electroless plating solution and the pressurized carbon dioxide are compatibly dissolved with each other, it is desirable to adopt the pressure at which the density of carbon dioxide is within the following range under the temperature condition to be carried out. The range of the density of the pressurized carbon dioxide is preferably 0.10 g/cm³ to 0.99 g/cm³ and more preferably 0.40 g/cm³ to 0.99 g/cm³. If the density of the pressurized carbon dioxide is lower than the range described above, then the compatibility between the pressurized carbon dioxide and the electroless plating solution is lowered, and then the permeability performance or the impregnation performance into the polymer member is lowered as well. On the other hand, if it is intended to raise the density of the pressurized carbon dioxide to be higher than the range described above, then it is necessary that the pressure of the pressurized carbon dioxide is extremely raised (for example, the pressure is required to be not less than 30 MPa at a temperature of 10° C., and the pressure is required to be not less than 40 MPa at a temperature of 20° C.), and an apparatus for the mass production of plated polymer becomes economical.

In order to obtain the density within the range described above, it is desirable that the carbon dioxide has a temperature of 10° C. to 110° C. and a pressure of 5 MPa to 25 MPa. In particular, the pressurized carbon dioxide is converted into supercritical carbon dioxide when the temperature is equal to or higher than 31° C. and the pressure is equal to or larger than 7.38 MPa, which is desirable. When the pressurized carbon dioxide is in the supercritical state, then not only the density of the pressurized carbon dioxide is merely raised, but the surface tension of the plating solution is also zero. Therefore, the permeability (infiltration performance) of the plating solution into the polymer member is extremely improved. On the other hand, troubles arise, for example, such that the plating reaction is hardly caused if the temperature is not more than 10° C., and that the plating solution is decomposed if the temperature is equal to or higher than 110° C. Further, if the pressure is not more than 5 MPa, the density of the pressurized carbon dioxide is greatly lowered. If the pressure is equal to or larger than 25 MPa, the load is exerted on the apparatus for the industrial production.

In this specification, the term “electroless plating method” means a method which uses no external electrical power source, wherein a metal coating film is deposited on a surface of a base material having a catalytic activity by using a reducing agent. In this specification, the “surface internal portion” of the polymer member includes not only the inside portion of the polymer member but also the outermost surface of the polymer member. In this specification, the “surface for forming the plating film” or the “plating film-forming surface” of the polymer member means a surface (entire surface or partial surface) of the polymer member on which the plating film is to be formed.

The present inventors have diligently investigated the electroless plating method (second conventional plating method) based on the use of the electroless plating solution added with the supercritical carbon dioxide disclosed, for example, in Japanese Patent No. 3571627 and “Surface Technology”, Vol. 56, No. 2, p. 83 (2005). As a result, for example, when the polymer member is merely impregnated with the metal substance (for example, metallic fine particles) to serve as the plating catalyst cores, and then the polymer member makes contact with the electroless plating solution added with the pressurized carbon dioxide (electroless plating solution in a state in which the plating reaction is to be caused) in accordance with the above-mentioned second conventional plating method, then the electroless plating film can be formed on the surface of the polymer member, but it is difficult to obtain any sufficient adhesion performance of the plating film. That is, any strong adhesion performance between the plating film and the molded article cannot be obtained by merely impregnating the polymer member with the metal substance to serve as the plating catalyst cores and making contact the polymer member with the electroless plating solution together with the pressurized carbon dioxide.

According to a verifying experiment performed by the present inventors, in the case of this exemplary investigation, the plating film principally grows by using the catalyst cores of the metal substance existing at the outermost surface of the polymer member. That is, the plating film hardly grows from the internal portion of the polymer member (inside portion of the surface internal portion). It is difficult to obtain the physical anchoring effect of the plating film.

The reason thereof is firstly considered as follows. That is, the concentration of the metal substance existing at the outermost surface of the polymer member (outermost surface of the surface internal portion) is higher than the concentration of the metal substance existing at the inside of the polymer member (inside portion of the surface internal portion). Further, the concentration is to such an extent that the plating reaction occurs at the atmospheric pressure. Secondly, it is considered that the plating film consequently grows from the metal substance disposed at the outermost surface, when the electroless plating treatment is applied to such a polymer member by means of the second conventional electroless plating method as disclosed, for example, in Japanese Patent No. 3571627 and “Surface Technology”, Vol. 56, No. 2, p. 83 (2005). Due to the causes as described above, it is considered that any strong adhesion performance cannot be obtained between the plating film and the molded article.

Distinctly from the method as described above, the present inventors have further investigated the surface modification method based on the use of the supercritical carbon dioxide disclosed in Japanese Patent No. 3696878. As a result, the following fact has been revealed. That is, when the staying time of the metal complex is prolonged in the plasticizing cylinder, then the metal complex is thermally decomposed to form the metallic fine particles which are coagulated. Further, the following phenomenon has been found out. That is, in the coagulated state, the metallic fine particles are hardly dispersed in the outermost surface of the molded article, although the fountain flow phenomenon is caused during the injection. It is considered that the specific gravity of the metallic fine particle is heavier than the specific gravity of the metal complex.

That is, the following facts have been revealed in relation to the surface modification method disclosed in Japanese Patent No. 3696878.

The concentration of the plating catalyst cores (metal substance) at the outermost surface of the obtained molded article can be lowered in accordance with the molding condition, for example, the staying time in the plasticizing cylinder of the metal complex.

In addition, if the concentration of the plating catalyst cores or metal substances is lowered at the outermost surface of the molded article, it is impossible to obtain any plating quality, that is, it is impossible to form any plating film having the satisfactory adhesion force by the conventional electroless plating method (first conventional plating method based on the use of the electroless plating solution added with no pressurized carbon dioxide), even though the molded article has the plating film-forming surface by the catalyst cores.

The present invention has been made on the basis of the unique recognition and the investigations as described above. In the method for forming the plating film of the present invention, at first, the polymer member is prepared, which includes the metal substance including, for example, Pd, Ni, Pt, and/or Cu to serve as the plating catalyst cores existing in the internal portion of the polymer member and which has the plating film-forming surface in such a surface state that the electroless plating reaction is not caused at the atmospheric pressure. For example, in the case of the impregnation with the metal substance over a range ranging from the outermost surface of the polymer member (outermost surface of the surface internal portion) to the internal portion (inside portion of the surface internal portion), the polymer member is prepared, which has an area disposed in the internal portion (inside portion of the surface internal portion), the area including the metal substance existing at the high concentration as compared with the outermost surface. More specifically, for example, the polymer member is prepared, which includes the metal substance in the internal portion (inside portion of the surface internal portion) at the concentration at which the plating reaction is sufficiently caused at the atmospheric pressure if the internal portion (inside portion) is the outermost surface of the polymer member, wherein the concentration of the metal substance at the outermost surface of the polymer member or the outermost layer (i.e., the outermost surface of the surface internal portion) is such a concentration that the electroless plating reaction is not caused at the atmospheric pressure (the catalytic activity is sufficiently low).

As referred to in this specification, the state in which the member is inactive with respect to the electroless plating solution at the atmospheric pressure or the state in which the electroless plating reaction is not caused at the atmospheric pressure means such a state that the plating film does not grow on the surface of the polymer member even when the polymer member is immersed in the electroless plating solution not added with the pressurized carbon dioxide in the atmospheric air (at the atmospheric pressure) at the temperature at which the plating reaction is capable of being caused. More specifically, such a surface state means that the plating film does not grow on the entire surface of the polymer member, when the polymer member is allowed to stay for 5 minutes or longer in the electroless plating solution not added with the pressurized carbon dioxide in the atmospheric air within the temperature range in which the plating reaction can be caused. Even when the metal substance to serve as the plating catalyst cores is present on the surface of the polymer member, if the concentration thereof is low, then the plating reaction is not caused with ease.

Subsequently, in the method for forming the plating film of the present invention, the electroless plating solution, to which the pressurized carbon dioxide is added, is allowed to make contact with the polymer member having the plating film-forming surface in the state as described above to permeate the electroless plating solution into the internal portion of the polymer member (inside portion of the surface internal portion). That is, the electroless plating solution cannot be permeated by itself into the internal portion of the polymer member (inside portion of the surface internal portion), because the surface tension is large. However, in the present invention, the pressurized carbon dioxide is added to the electroless plating solution, and thus the surface tension of the electroless plating solution is lowered. Therefore, the electroless plating solution can be easily permeated into the internal portion of the polymer member (inside portion of the surface internal portion).

In this situation, as described above, the concentration of the metal substance is sufficiently low at the plating film-forming surface (outermost surface of the surface internal portion). That is, the concentration of the metal substance at the plating film-forming surface is such a concentration that the plating film-forming surface is inactive with respect to the electroless plating solution at the atmospheric pressure. Therefore, the plating film does not grow from the plating film-forming surface (outermost surface of the surface internal portion). When the electroless plating solution is permeated into the internal portion of the polymer member (inside portion of the surface internal portion), i.e., into the area in which the concentration of the metal substance is high, the plating reaction is started from the area. After that, the plating film grows from the internal portion of the polymer (inside portion of the surface internal portion) toward the surface in accordance with the autocatalytic action of the metal substance of the nickel-phosphorus plating or the like.

If the metal substance, which serves as the plating catalyst cores, is present at the concentration to such an extent that the plating reaction is caused on the outermost surface of the polymer member (plating film-forming surface), the electroless plating solution causes the plating reaction on the surface layer (outermost surface of the surface internal portion), before the electroless plating solution is permeated into the internal portion of the polymer member (inside portion of the surface internal portion). As a result, the plating film hardly grows from the internal portion of the polymer (inside portion of the surface internal portion).

As described above, in the method for forming the plating film of the present invention, the plating film grows (plating reaction is started) by using the catalyst cores of the metal substance existing in the internal portion of the polymer member (inside portion of the surface internal portion). Therefore, the plating film is formed on the polymer member in such a state that the plating film bites into the internal portion of the polymer member (inside portion of the surface internal portion). Accordingly, the adhesion performance of the plating film is extremely enhanced as compared with the adhesion performance of any plating film obtained by the second conventional plating method.

In the method for forming the plating film of the present invention, it is unnecessary to roughen the surface of the polymer member by means of the etching unlike the first conventional electroless plating method. The method for forming the plating film of the present invention is the method for forming the plating film that is mild or gentle with respect to the environment. Further, the plating film, which is excellent in the adhesion performance, can be easily formed on various types of polymer members.

Further, in the method for forming the plating film of the present invention, it is unnecessary to roughen the surface of the polymer member unlike the first conventional electroless plating method. Therefore, the surface roughness of the plating film is extremely small, and the surface roughness is in the nano-order.

In the method for forming the plating film of the present invention, the metal substance may be any one of metallic fine particles, a metal complex, and a modified material of the metal complex. Specifically, the metal substance, with which the polymer member is to be impregnated, may be either the fine particles (metallic fine particles) composed of any one of metal elements of Pd, Pt, Cu, and Ni, or the organic metal complex thereof or the modified material of the metal complex. In particular, the metal complex is appropriate, because the metal complex is dissolved in the pressurized carbon dioxide. The metal substance may be a material modified into oxide or metallic fine particles by being reduced, for example, by means of the heating after the metal complex is dissolved in the pressurized carbon dioxide and is permeated into the polymer member. Further, palladium fine particles may be used as the metal substance, because palladium fine particles function as the catalyst cores of various types of electroless plating processes. Further, nickel and copper function as the catalyst cores of the nickel plating and the copper plating respectively. Therefore, nickel or copper may be used as the metallic fine particles. Nickel and copper are more inexpensive than palladium, which are preferred in view of the cost as well.

In the method for forming the plating film of the present invention, the preparation of the polymer member may include introducing, in a molding machine, the pressurized carbon dioxide in which the metal substance has been dissolved into a melted resin for forming the polymer member; and molding the melted resin into which the metal substance has been introduced.

In the method for forming the plating film of the present invention, the following methods may be available to manufacture the polymer member which includes the metal substance existing in the internal portion of the polymer member to serve as the plating catalyst cores and which has the surface for forming the plating film to cause no electroless plating reaction at the atmospheric pressure, for example, to manufacture the polymer member which has, in the internal portion (inside portion of the surface internal portion), the area including the metal substance existing at the higher concentration as compared with the outermost surface of the surface internal portion. That is, for example, the metal substance of the metal complex or the like is permeated and kneaded together with the pressurized carbon dioxide into the resin which is in a state of being melted in the plasticizing cylinder of the injection molding machine or the extrusion molding machine. Further, the melted resin, which is impregnated with the metal substance, may be injected into the mold or the die so that the melted resin is molded, or the melted resin may be extruded and molded to manufacture the polymer member. In such a procedure, for example, when the melted resin is injected into or extruded from the mold or the die at a low speed, then the metal substance enters the interior of the resin, and the metal substance hardly floats on the outermost surface of the molded article (outermost surface of the surface internal portion).

When the polymer member is molded by means of the injection molding, as described above, if the period of time, in which the metal complex stays in the plasticizing cylinder, is prolonged, then the metal complex is thermally decomposed into the metallic fine particles, and the metallic fine particles are coagulated. As a result, the specific gravity of the metallic fine particles becomes heavy. Therefore, even when the fountain flow phenomenon arises during the injection, the metallic fine particles are hardly dispersed in the outermost surface of the molded article (outermost surface of the surface internal portion). Therefore, the concentration of the metallic fine particles (metal substance) can be also lowered at the outermost surface of the polymer member (outermost surface of the surface internal portion) to provide the surface state in which the electroless plating reaction is not caused under the atmospheric pressure by providing a period of time in which the metal complex is allowed to stay in the plasticizing cylinder and appropriately adjusting the staying time.

In order to manufacture the polymer member having the plating film-forming surface on which the electroless plating reaction is not caused at the atmospheric pressure although the metal substance to serve as the plating catalyst cores is present in the internal portion of the polymer member, the internal pressure of the resin may be reduced after sufficiently impregnating the melted resin with the metal complex (metal substance) as described later on (see the first embodiment). When the pressure-reducing process is performed as described above, then the metal complex can be thermally decomposed at a high temperature and a high pressure to form the cluster by the thermally decomposed metal complex, and the metal complex as the organic matter can be changed into the metallic fine particles having the heavier specific gravity. When the pressure is reduced as described above, the carbon dioxide is also converted into the low pressure gas. When the melted resin in this state is injected and charged, the metallic fine particles and the carbon dioxide gas are hardly dispersed (hardly allowed to float) at the outermost surface of the polymer member (outermost surface of the surface internal portion).

As described above, when the melted resin of the polymer member in the molding machine is impregnated with the metal substance to mold the polymer member, it is possible by appropriately adjusting the molding condition to manufacture the polymer member having the plating film-forming surface on which the electroless plating reaction is not caused at the atmospheric pressure although the metal substance to serve as the plating catalyst cores is present in the internal portion. Other than the above, for example, even when the pellets of the polymer previously impregnated with the metal substance and the pellets of the polymer not impregnated with the metal substance are used in combination, the polymer member, in which the metal substance exists while satisfying the condition described above, can be obtained by optimizing the molding condition. For example, the melted resin of the pellets of the polymer not impregnated with the metal substance is firstly injected, the melted resin of the pellets of the polymer impregnated with the metal substance is subsequently injected, and the melted resin of the pellets of the polymer not impregnated with the metal substance is finally injected. When this molding condition is adopted, it is possible to obtain the polymer member in which the metal substance is present while satisfying the condition described above.

When the method, in which the polymer member is molded by impregnating the melted resin in the molding machine with the metal substance as described above, is used as the method for manufacturing the polymer member which includes the metal substance existing in the internal portion of the polymer member and which has the plating film-forming surface for causing no electroless plating reaction at the atmospheric pressure, then the internal portion of the polymer member (surface internal portion) can be appropriately impregnated with the metal substance which serves as the catalyst cores of the plating film, simultaneously with the molding of the polymer member. Therefore, the polymer member, in which the internal portion (surface internal portion) is appropriately impregnated with the metal substance, can be manufactured by means of the easy and economical process. In the method for molding the polymer member according to the present invention, it is possible to use any other injection molding method (or the sandwich molding method) or the extrusion molding method.

The following method may be used as the method in which the plating film-forming surface of the polymer member is allowed to be in such a state that the electroless plating reaction is not caused at the atmospheric pressure.

At first, the polymer member, in which the metal substance also exists on the outermost surface, is manufactured at the concentration to such an extent that the electroless plating reaction is caused at the atmospheric pressure, by using, for example, the molding machine. Subsequently, the polymer member is washed with acid including, for example, nitric acid, hydrochloric acid, and aqua regia to remove the metal substance disposed at the outermost surface. Accordingly, the outermost surface of the polymer member may be allowed to be in the state in which the plating reaction is not caused (state in which the outermost surface is inactive with respect to the electroless plating solution).

Another method is also available. At first, the polymer member is manufactured by using, for example, the molding machine, in which the metal substance also exists on the outermost surface at the concentration to such an extent that the electroless plating reaction is caused at the atmospheric pressure. Subsequently, a film, which is composed of a material to permeate the electroless plating solution added with the pressurized carbon dioxide therethrough (for example, the same material as that of the polymer member, the material not containing the metal substance), may be formed on the polymer member. Such a film can be formed on the polymer member by means of the method including, for example, the casting, the screen printing, the spin coat, and the dipping. In this method, the film, in which the metal substance is absent, is formed on the surface of the polymer member. Therefore, the plating reaction is not caused under the atmospheric pressure.

Those usable as the material for forming the film as described above include, for example, thermoplastic resins such as polycarbonate, polymethyl methacrylate, cycloolefin, and polymer, thermosetting resins such as silicone, epoxy, and polyimide, photocurable resins such as acrylic and epoxy, and porous materials thereof.

In the method for forming the plating film of the present invention, the electroless plating solution may contain alcohol.

According to the investigations performed by the present inventors, in the case of the electroless plating method (second conventional plating method) based on the use of the electroless plating solution added with the supercritical carbon dioxide as disclosed in Japanese Patent No. 3571627 and “Surface Technology”, Vol. 56, No. 2, p. 83 (2005), the carbon dioxide in the high pressure state and the electroless plating solution as the aqueous solution are hardly compatibly dissolved with each other, even when any surfactant is used. Actually, in order to compatibly dissolve them, it has been necessary that a stirring bar having a high agitation torque is used and/or a high pressure container having a shallow bottom is used to enhance the agitation effect. That is, in the case of the second conventional plating method, there are strictly limitations or restrictions in, for example, the shape of the high pressure container, the shape of the stirring bar, and the number of revolutions of the stirring bar, in order to obtain a stable emulsion by homogeneously or uniformly mixing the electroless plating solution and the pressurized carbon dioxide.

In view of the above, the present inventors have repeatedly made the investigations in order to solve this problem. As a result, the following fact has been revealed. That is, the electroless plating solution is usually prepared by using water as the main component. However, when alcohol is intentionally mixed, the carbon dioxide in the high pressure state and the plating solution are easily and stably mixed with each other, even when no agitation is performed. It may be considered that alcohol is compatibly dissolved in the carbon dioxide in the high pressure state with ease.

Usually, when the electroless plating solution is prepared or formulated, the preparation is performed (bath is prepared) such that the undiluted solution, which contains, for example, metal ions and reducing agent, is diluted with water in accordance with the component ratio recommended by the manufacturer. However, in the present invention, the preparation may be performed (bath may be prepared) such that the undiluted solution is diluted with a liquid obtained by mixing alcohol with water at an arbitrary ratio. Accordingly, the electroless plating solution and the pressurized carbon dioxide are subjected to the homogeneous compatible dissolution, and thus a stable mixed solution can be formulated or prepared.

The volume ratio between water and alcohol to be mixed is arbitrary. However, the volume ratio of alcohol is preferably within a range of 10 to 80% of the total of the mixture solution, and more desirably within a range of 30 to 60%. If the alcohol component is less than this range, then it is difficult to obtain any stable mixed solution, and the permeability of the electroless plating solution into the polymer member is lowered as well. On the other hand, if the alcohol component is more than this range, for example, an obtained bath is unstable in some cases in view of any other meaning, for example, because nickel sulfate, which is used for the nickel-phosphorus plating, has such a characteristic that nickel sulfate is insoluble in an organic solvent such as ethanol.

The type of alcohol capable of being used in the present invention is arbitrary. For example, it is possible to use methanol, ethanol, n-propanol, isopropanol, butanol, heptanol, and ethylene glycol. For example, in the nickel-phosphorus plating in which the plating reaction temperature is about 60° C. or higher, it is also allowable to use alcohol having a boiling point of the reaction treatment temperature or higher. If alcohol, which has a boiling point lower than the treatment temperature, is used, alcohol is not boiled, because the boiling point of alcohol is lowered by the high pressure in the pressurized carbon dioxide atmosphere. However, alcohol is volatilized at the atmospheric pressure after discharging the carbon dioxide, and the plating bath is unstable.

In the method for forming the plating film of the present invention, the electroless plating solution may contain a surfactant. Accordingly, it is possible to further improve the compatibility (affinity) between the pressurized carbon dioxide such as the supercritical carbon dioxide and the electroless plating solution as the aqueous solution, and it is possible to facilitate the formation of the emulsion. Further, it is also possible to improve the affinity of the plating solution for the polymer member.

As for the surfactant, it is also allowable to select and use at least one or two or more of known surfactants including nonionic, anionic, cationic, and amphoteric surfactants. In particular, it is also allowable to use various surfactants which have been confirmed to be effective to form the emulsion of the supercritical carbon dioxide and water. For example, it is possible to use, block copolymer of polyethylene oxide (PEO)-polypropylene oxide (PPO), ammonium carboxylate perfluoropolyether (PFPE), block copolymer of PEO-polybutylene oxide (PBO), and octaethylene glycol monododecyl ether.

In the method for forming the plating film of the present invention, the plating film may be a nickel-phosphorus film. In the present invention, pH (hydrogen ion exponent) is lowered by adding carbon dioxide in the electroless plating solution added with the pressurized carbon dioxide. That is, in the method for forming the plating film of the present invention, pH of the electroless plating solution is changed depending on the content of carbon dioxide. Therefore, it is desirable to use the electroless plating solution which is originally acidic and which stably reacts irrelevant to the content of carbon dioxide. The nickel-phosphorus plating is capable of making the plating reaction within a wide range in which pH is about 3 to 6, which is suitable.

In the method for forming the plating film of the present invention, a minimum thin metal film may be formed in a short period of time on the surface of the polymer member to secure the adhesion performance between the metal film and the polymer member. When the period of time, in which the metal film is formed, is made short, then it is possible to suppress any excessive permeation of the electroless plating solution into the internal portion of the polymer member, and it is possible to suppress any deformation and any quality change of the polymer member which would be otherwise caused by the electroless plating solution. When it is necessary to thicken the plating film, then the electroless plating film is firstly formed by means of the method of the present invention as described above, and then a film having a desired film thickness may be stacked at the ordinary pressure by means of the conventional plating method (electroless plating solution and/or electroplating method). In this two-step method, it is possible to satisfy both of the reliability (adhesion performance) of the metal film and the reliable acquisition of the physical property such as the conductivity owing to the film thickness.

In the method for forming the plating film of the present invention, the polymer member is prepared such that an elutable substance exists in the internal portion of the surface of the polymer member, the elutable substance being dissolvable in the electroless plating solution to which the pressurized carbon dioxide has been added. In particular, the elutable substance may be a mineral.

According to the investigations performed by the present inventors, it has been revealed that the mixed solvent, which contains the pressurized carbon dioxide, water, and alcohol, has the strong oxidizing power, and the mixed solvent dissolves the substance which is dissolvable in the acidic solvent. In particular, the dissolving phenomenon is remarkable in the mixed solvent of the pressurized carbon dioxide and the electroless plating solution as the acidic bath. Therefore, when the polymer member, in which the substance capable of being dissolved in the electroless plating solution added with the pressurized carbon dioxide exists in the surface internal portion, is prepared, then the elutable substance in the surface internal portion of the polymer member is dissolved and eluted into the electroless plating solution by making contact the electroless plating solution added with the pressurized carbon dioxide with the polymer member, and the voids can be formed in the areas in which the elutable substance has been present.

As a result, the irregularities are formed on the surface of the polymer member, and the plating film enters or bites into the irregularities. Accordingly, the physical anchoring effect of the plating film is enhanced on the surface of the polymer member, and it is possible to further improve the adhesive force of the plating film. In this method, the surface of the polymer member can be subjected to the etching without using any harmful organic solvent having been used in the conventional plating method. Further, when the polymer member, in which the elutable substance exists in the surface internal portion of the polymer member, is used, the mixed solvent can be permeated through the voids, when the mixed solvent of the pressurized carbon dioxide and the electroless plating solution is allowed to make contact with the polymer member. Therefore, the mixed solvent is easily permeated into the polymer member.

Any arbitrary material may be used as the elutable substance which is usable in the method for forming the plating film of the present invention, provided that the material is dissolvable in the electroless plating solution to which the pressurized carbon dioxide is added. For example, it is possible to use the mineral including, for example, calcium carbonate and magnesium carbonate. The mineral as described above has been hitherto used as a reinforcing agent for the polymer member. Therefore, the mineral does not change the physical property of the polymer. The elutable substance may be extracted from the polymer member during the plating reaction. Alternatively, the elutable substance may be previously extracted from the polymer member by making contact with water, alcohol, or any mixed solvent of water and/or alcohol and the pressurized carbon dioxide before the plating reaction.

Those other than the mineral, which are useable as the elutable substance, may include, for example, thermoplastic resins, low molecular weight substances thereof, and various elastomers such as thermoplastic elastomers (rubber elastic materials). When the resin material of the base polymer is blended with the resin substance as described above, the portion, in which the substance to be selectively melted is present, can be subjected to the swelling, when the electroless plating solution added with the pressurized carbon dioxide is allowed to make contact with the polymer member. Accordingly, the electroless plating solution is permeated with ease.

In the method for forming the plating film of the present invention, the formation of the plating film on the polymer member comprises using a treatment container including a container body made of a metal, and an inner container arranged in the container body and formed of a material inactive to the electroless plating solution to which the pressurized carbon dioxide has been added; and bringing, in the inner container, the polymer member into contact with the electroless plating solution to which the pressurized carbon dioxide has been added. Those usable as the material forming the inner container may include, for example, polytetrafluoroethylene, polyethylether ketone, and liquid crystal polymer. When the plating treatment is performed in the inner container as described above, the effect is obtained, for example, such that the inner wall of the inner container and the high pressure container are not plated, and they are not subjected to any corrosion.

Any arbitrary material is available to form the polymer member which is usable for the method for forming the plating film of the present invention. It is also allowable to use thermoplastic resins, thermosetting resins, and ultraviolet-curable resins. In particular, it is preferable to use thermoplastic resins. The type of the thermoplastic resin is arbitrary. It is possible to apply any one of amorphous or non-crystalline and crystalline resins. For example, it is possible to use synthetic fiber based on polyester or the like, polypropylene, polyamide-based resin, polymethyl methacrylate, polycarbonate, amorphous polyolefin, polyether imide, polyethylene terephthalate, liquid crystal polymer, ABS-based resin, polyamide imide, polyphthal amide, polyphenylene sulfide, biodegradable plastic such as polylactic acid, nylon resin, and composite materials thereof. It is also possible to use resin materials obtained by being kneaded with, for example, glass fiber, carbon fiber, nanocarbon, mineral, and various inorganic fillers such as minerals.

In the method for forming the plating film of the present invention, the form of the polymer member and the manufacturing method are arbitrary. For example, it is possible to use sheets and pipes manufactured by the extrusion molding and polymer molded articles manufactured by the ultraviolet curing and the injection molding. In view of the industrial applicability, it is preferable to use the polymer molded article obtained by the injection molding which has the high continuous productivity.

According to a third aspect of the present invention, there is provided a polymer member on which a plating film is to be formed with an electroless plating solution, the polymer member comprising a polymer base material having an internal portion and a metal substance, which is impregnated in the internal portion and which serves as plating catalyst cores; and an inactive surface of the polymer base material, on which the plating film is to be formed, is inactive to the electroless plating solution at an atmospheric pressure.

According to a fourth aspect of the present invention, there is provided a polymer member on which a plating film is to be formed with an electroless plating solution, the polymer member comprising a polymer base material which includes a surface outermost portion and an inside portion, and a metal substance, which is impregnated in the surface outermost portion and the inside portion which serves as plating catalyst cores, wherein the metal substance is contained in the inside portion higher than in the surface outermost portion.

In the polymer member of the present invention, an elutable substance further exists in the surface internal portion of the polymer base material, the elutable substance being dissolvable by the electroless plating solution to which pressurized carbon dioxide has been added. In particular, the elutable substance may be a mineral.

The polymer member of the present invention may further comprise the plating film formed on the polymer base material. In particular, the plating film may include nickel. Further, the metal substance may include palladium.

According to a fifth aspect of the present invention, there is provided a method for producing the polymer member as defined in the third or fourth aspect by using a molding machine; the method comprising introducing, in the molding machine, pressurized carbon dioxide in which the metal substance is dissolved into a melted resin for forming the polymer member; and molding the melted resin into which the metal substance has been introduced.

According to the method for forming the plating film of the present invention, the plating film, which grows from the inside portion of the polymer member, can be formed on the polymer member. Therefore, it is possible to form the plating film which is excellent in the adhesion performance.

According to the method for forming the plating film of the present invention, the electroless plating solution is permeated into the internal portion of the polymer member (inside portion of the surface internal portion), and the plating reaction is caused in the internal portion. Therefore, it is unnecessary to roughen the surface of the polymer member unlike the conventional technique. The plating film, which is excellent in the adhesion performance, can be formed on all types of the polymer members.

In the method for forming the plating film of the present invention, for example, when the inner container made of resin is used, and the plating film is formed in the container, then the plating film can be suppressed from growing on any member (for example, the container body made of metal) other than the base material (polymer member) to be subjected to the plating. The plating reaction is stabilized in the container or vessel. Therefore, the plating solution is stabilized to such an extent that the same plating solution can be repeatedly used for a plurality of polymer members, and thus the method can be industrially carried out.

### BRIEF DESCRIPTION OF THE DRAWINGS

FIG. 1 shows a schematic arrangement of a production apparatus used in a first embodiment.

FIG. 2 shows a plasticizing cylinder shown in FIG. 1. FIG. 2A shows a situation at a point of time at which the plasticizing and weighing of a melted resin is completed. FIG. 2B shows a situation brought about when pressurized carbon dioxide, in which a metal complex is dissolved, is introduced.

FIG. 3 shows a situation at a point of time at which the injection molding of a polymer molded article is completed.

FIG. 4 shows a situation in which the electroless plating treatment is performed for the polymer molded article in the production apparatus shown in FIG. 1.

FIG. 5 shows a flow chart illustrating a method for forming the plating film according to the first embodiment.

FIG. 6 shows a schematic cross section of a part of the polymer molded article before the plating treatment after the molding in the first embodiment.

FIG. 7 shows a schematic cross section of a part of the polymer molded article manufactured in the first embodiment.

FIG. 8 shows a schematic arrangement of a molding machine used in a second embodiment.

FIG. 9 shows a state at a certain point of time of the molding machine shown in FIG. 8 (at a point of time of the completion of the previous sandwich molding).

FIG. 10 shows a state at a certain point of time of the molding machine shown in FIG. 8 (at a point of time of the completion of the plasticizing and weighing of a first melted resin).

FIG. 11 shows a state at a certain point of time of the molding machine shown in FIG. 8 (at a point of time of the start of the injection of the first melted resin).

FIG. 12 shows a state at a certain point of time of the molding machine shown in FIG. 8 (at a point of time immediately before the completion of the injection and charging of the first melted resin).

FIG. 13 shows a state at a certain point of time of the molding machine shown in FIG. 8 (at a point of time of the start of the injection of a second melted resin).

FIG. 14 shows a state at a certain point of time of the molding machine shown in FIG. 8 (at a point of time after the completion of the injection of the second melted resin).

FIG. 15 shows a flow chart illustrating a method for forming the plating film according to the second embodiment.

### DESCRIPTION OF THE PREFERRED EMBODIMENTS

An explanation will be specifically made below with reference to the drawings about embodiments of the method for forming the plating film on the polymer member and the polymer member of the present invention. The embodiments described below are preferred specified examples of the present invention. However, the present invention is not limited to the following embodiments.

### First Embodiment

In this first embodiment, an explanation will be made about a method in which a polymer molded article (polymer member, polymer base material) is injected and molded by using an injection molding machine, and then the electroless plating treatment is performed in the same injection molding machine. In this embodiment, an automobile head light reflector was manufactured as the polymer member.

### Production Apparatus for Polymer Molded Article

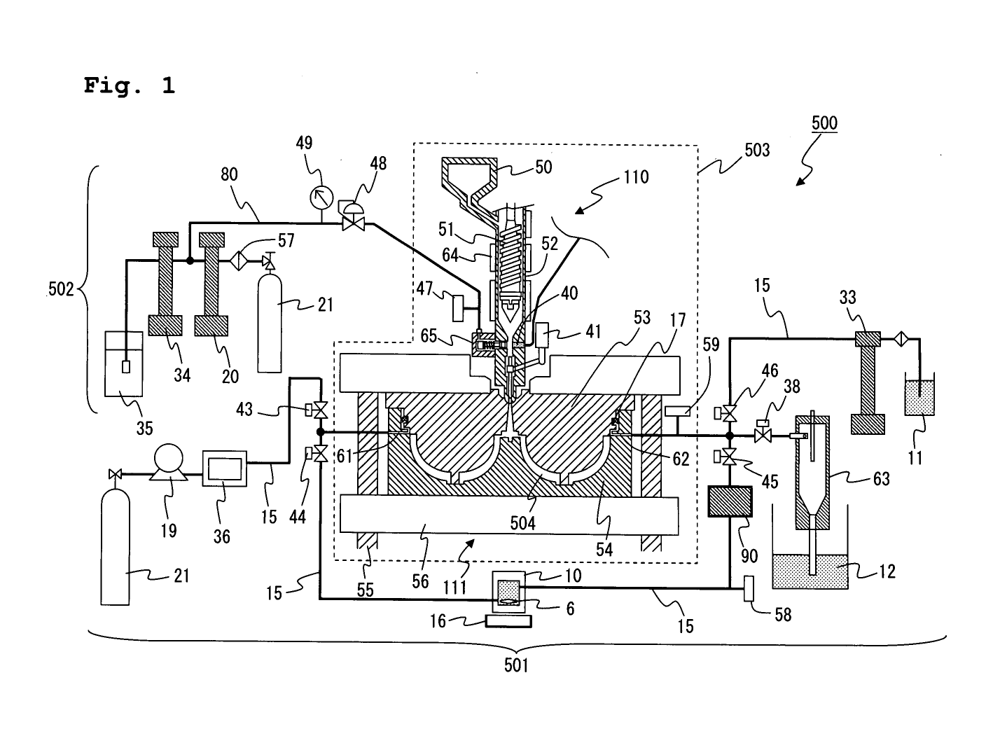

FIG. 1 shows a schematic arrangement of a production apparatus for the polymer molded article used in this embodiment. As shown in FIG. 1, the production apparatus 500 of this embodiment principally comprises a vertical type injection molding section 503 which includes a mold 53 and 54, an electroless plating section 501 which controls the supply of the electroless plating solution added with pressurized carbon dioxide to the mold 53 and 54 and the discharge from the mold 53 and 54, and a surface modifying section 502 which allows the pressurized carbon dioxide dissolved with the metal complex to permeate into the melted resin contained in a plasticizing cylinder 52 of the injection molding section 503.

As shown in FIG. 1, the vertical type injection molding section 503 principally includes a plasticizing melting module 110 in which the resin to be formed as the polymer molded article (polymer member) is plasticized and melted, and a clamping module 111 which opens/closes the mold 53 and 54.

The plasticizing and melting module 110 principally includes the plasticizing cylinder 52 which contains a screw 51, a hopper 50, and a valve 65 which is provided in the vicinity of the forward end (flow front portion) in the plasticizing cylinder 52 to introduce the pressurized carbon dioxide. A pressure sensor 40, which measures the internal pressure of the resin at the position opposed to the introducing valve 65, is provided for the plasticizing cylinder 52. Polyphenylene sulfide (FZ-8600 Black produced by Dainippon Ink and Chemicals, Incorporated) was used as the material of unillustrated resin pellets to be supplied from the inside of the hopper 50 to the inside of the plasticizing cylinder 52.

The clamping module 111 principally includes a fixed mold 53 and a movable mold 54. The movable mold 54 is fixed to a movable platen 56, and it is movable along with four tie bars 55 in accordance with the driving of an unillustrated hydraulic pressure clamping mechanism. The movable mold 54 is opened/closed with respect to the fixed mold 53 in accordance with the movement. A cavity 504 is defined between the movable mold 54 and the fixed mold 53 in closed position.

The movable mold 54 has plating solution-introducing passages 61, 62 which are connected to the cavity 504. As shown in FIG. 1, a piping 15 of the electroless plating section 501 described later on is connected to the plating solution-introducing passages 61, 62. The pressurized carbon dioxide and the electroless plating solution are introduced into the cavity 504 from one of the piping 15. Further, the pressurized carbon dioxide and the electroless plating solution contained in the cavity 504 are discharged from another of the piping 15. A spring-containing seal 17 is provided at the outer diameter portion of the fixed mold 53 and the cavity 504 is sealed when the spring-containing seal 17 is fitted to the movable mold 54.

As shown in FIG. 1, the surface modifying section 502 principally includes a liquid carbon dioxide bottle 21, syringe pumps 20, 34, a filter 57, a back pressure valve 48, a dissolving tank 35 in which the metal complex is dissolved in the pressurized carbon dioxide, and a piping 80 which connects these constitutive components. As shown in FIG. 1, the piping 80 of the surface modifying section 502 is connected to the introducing valve 65 of the plasticizing cylinder 52. A pressure sensor 47 is provided for the piping 80 in the vicinity of the introducing valve 65. In this embodiment, a metal complex (hexafluoroacetyl-acetonato palladium (II)) was used as the row material of the metallic fine particles (metal substance) charged in the dissolving tank 35.

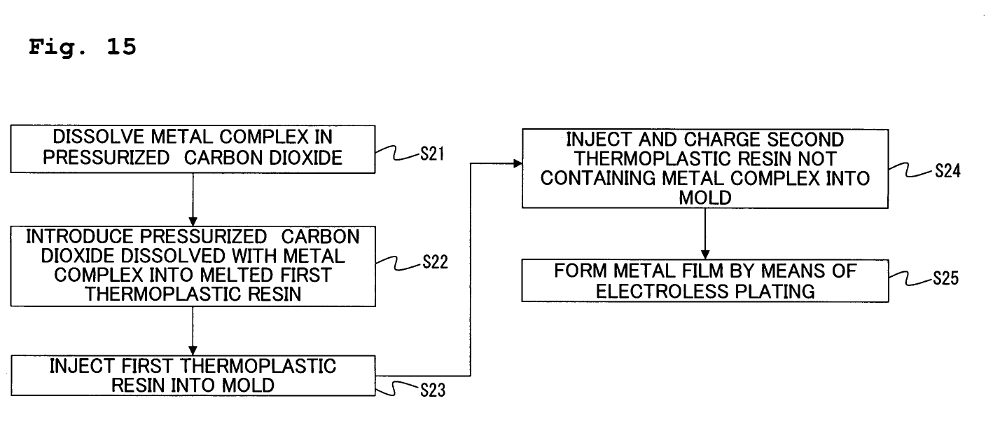

As shown in FIG. 1, the electroless plating section 501 principally includes a liquid carbon dioxide bottle 21, a pump 19, a buffer tank 36, a high pressure container 10 in which the electroless plating solution and the pressurized carbon dioxide are mixed, a circulation pump 90, a plating tank 11 which is provided to supplement the electroless plating solution, a syringe pump 33, a recovery container 63 which recovers the electroless plating solution, a recovery tank 12, and a piping 15 which connects these constitutive components. Automatic valves 43 to 46, 38, which control the flow of the pressurized carbon dioxide and the electroless plating solution, are provided at predetermined positions of the piping 15. As shown in FIG. 15, the piping 15 is connected to the plating solution-introducing passages 61, 62 of the movable mold 54. In this embodiment, a nickel-phosphorus electroless plating solution containing 15% of an undiluted solution and 50% by volume of alcohol (ethanol) was used as the electroless plating solution.

### Method for Molding Polymer Molded Article

Next, an explanation will be made about a method for molding the polymer molded article in which the surface internal portion is impregnated with the metallic fine particles. In the present invention, any arbitrary method is available to impregnate the resin with the metal complex. However, in this embodiment, the melted resin was plasticized and weighed in the plasticizing cylinder 52, and then or during the weighting process the pressurized carbon dioxide, in which the metal complex was dissolved, was introduced into the forward end portion (flow front portion) of the plasticizing cylinder 52.

At first, the metal complex was dissolved in ethanol in the dissolving tank 35. The ethanol, in which the metal complex was dissolved, was allowed to have a pressure raised to 15 MPa in the syringe pump 34. On the other hand, the liquid carbon dioxide was supplied from the liquid carbon dioxide bottle 21 via the filter 57 to the syringe pump 20. The pressure of the liquid carbon dioxide was raised to 15 MPa in the syringe pump 20. The carbon dioxide in the raised pressure and the ethanol dissolved with the metal complex in the raised pressure were mixed in the piping 80. Accordingly, the pressurized mixture fluid is produced.

When the pressurized mixture fluid was supplied to the plasticizing melting module 110, at first, the supply pressure of the pressurized mixture fluid was previously controlled by the back pressure valve 48 so that the indication of the pressure gauge 49 was 15 MPa. The control of each of the syringe pumps 20, 34 was switched from the pressure control to the flow rate control, and the pressurized mixture fluid of the pressurized ethanol solution and the pressurized carbon dioxide was fed from both of the syringe pumps 20, 34. Further, when the pressurized mixture fluid was supplied to the plasticizing melting module 110, the pressurized mixture fluid was supplied to the plasticizing melting module 110 while regulating the temperature at 50° C. by means of an unillustrated heater in the piping 80.

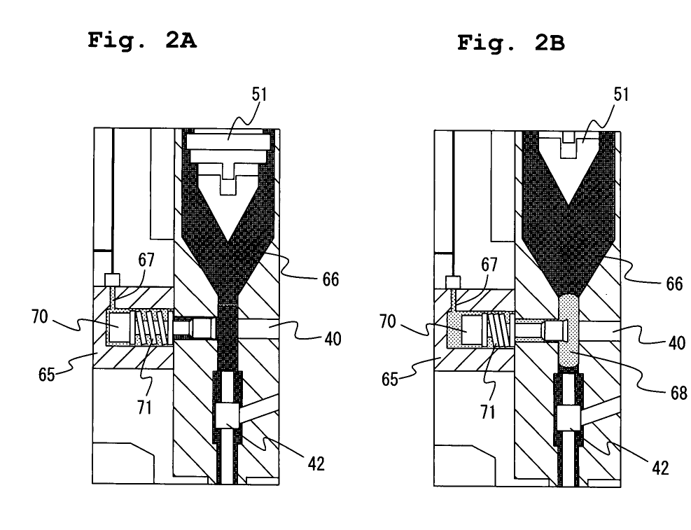

Next, an explanation will be made with reference to FIGS. 1 and 2 about the procedure for introducing the pressurized mixture fluid into the plasticizing melting module 110. FIGS. 2A and 2B show magnified sectional views illustrating those disposed in the vicinity of the introducing valve 65 of the plasticizing melting module 110.

At first, the screw 51 is rotated in the plasticizing cylinder 52 while supplying the resin pellets from the hopper 50 to plasticize and weigh the resin. FIG. 2A shows the state of those disposed in the vicinity of the introducing valve 65 upon the completion of the plasticizing and weighing. In this situation of FIG. 2A and in the weighing process, the introducing pin 70 of the introducing valve 65 stays in a backward position (in the left side position as viewed in FIG. 2A). Accordingly, the pressurized mixture fluid 67 is not introduced into the melted resin 66.

Subsequently, the pressurized mixture fluid 67 was introduced into the melted resin 66 at the flow front portion in the plasticizing cylinder 52 via the introducing valve 65 (state shown in FIG. 2B). Specifically, the screw 51 was subjected to the suck back (moved backwardly) in up direction of FIG. 2B to lower the internal pressure of the melted resin 66 contained in the plasticizing cylinder 52, simultaneously with which the both of the syringe pumps 20, 34 were switched from the pressure control to the flow control. The pressurized mixture fluid 67 was introduced into the melted resin 66, while the flow rate of the ethanol dissolved with the metal complex and the flow rate of the carbon dioxide were 1:10 in accordance with the method as described above respectively. The area 68 shown in FIG. 2B is the portion of the melted resin into which the pressurized mixture fluid 67 is permeated.

The introducing valve 65 of the plasticizing cylinder 52 of this embodiment has the following structure. That is, the introducing valve 65 is opened when the pressure difference between the pressure of the melted resin 66 and the pressure of the pressurized mixture fluid 67 is not less than 5 MPa, and thus the pressurized mixture fluid 67 is introduced into the melted resin 66 in the plasticizing cylinder 52. The principle of the introduction of the pressurized mixture fluid 67 by the introducing valve 65 is as follows. When the screw 51 is subjected to the suck back after the completion of the plasticizing and weighing, then the pressure of the melted resin 66 is reduced, and the density is lowered. When the pressure difference between the melted resin 66 and the pressurized mixture fluid 67 is not less than 5 MPa, then the pressure of the pressurized mixture fluid 67 overcomes the holding or returning force (elastic force) of the spring 71 contained in the introducing valve 65, the introducing pin 70 is moved frontwardly into the melted resin 66, and the pressurized mixture fluid 67 is introduced into the melted resin 66. Actually, the pressurized mixture fluid 67 was introduced at the above rate, while monitoring the pressure of the resin by means of the pressure sensor 40 and monitoring the pressure of the pressurized mixture fluid 67 by means of the pressure sensor 47.

Subsequently, the both of the syringe pumps 20, 34 were stopped to stop the feeding of the pressurized mixture fluid 67. Simultaneously, the screw 51 was moved frontwardly in down direction in FIG. 2B to raise the resin pressure to 20 MPa again, and the introducing pin 70 was forced to moved backwardly (moved in the leftward direction as viewed in FIG. 2B). Accordingly, the introduction of the pressurized mixture fluid 67 into the plasticizing cylinder 52 was stopped. The pressurized mixture fluid 67 and the melted resin 66 were compatibly dissolved with each other in the plasticizing cylinder 52.

Subsequently, the resin pressure was retained at 20 MPa, as the resin at the flow front portion in the plasticizing cylinder 52 to be sufficiently impregnated with the metal complex. After that, the internal pressure of the resin was reduced to 1 MPa. When the pressure and the temperature are retained at the high pressure and the high temperature as described above, then a greater part of the metal complex, with which the resin is impregnated, is thermally decomposed to form the cluster, and the metal complex as the organic compound is changed to the metallic fine particles having the heavier specific gravity. In accordance with the pressure reduction, the carbon dioxide is converted into the gas at the low pressure. As the flow front portion of the melted resin was allowed to be in the state as described above before the injection and charging, when the skin layer (surface internal portion) is formed by means of the injection and charging as described later on, both of the metallic fine particles and the carbon dioxide gas hardly float on the surface of the skin layer (outermost surface of the surface internal portion of the molded article).

After the introduction of the pressurized mixture fluid 67 into the plasticizing cylinder 52 was stopped, the unillustrated automatic valve in the piping 80 was closed to close the both of the syringe pumps 20, 34. After that, the both of the syringe pumps 20, 34 were supplemented with the pressurized carbon dioxide and the ethanol solution dissolved with the metal complex in the amounts corresponding to the amounts of the flow rate of the supply to the plasticizing melting module 110. After that, the both of the syringe pumps 20, 34 were switched to the pressure control, they are retained at a high pressure of 15 MPa, and they are allowed to wait until the feeding of the liquid for the next shot.

After the pressurized mixture fluid 67 was introduced into the melted resin 66 at the flow front portion in the plasticizing cylinder 52, the melted resin was injected and charged into the cavity 504 defined in the mold 53 and 54. The mold 53 and 54 was previously clamped by the hydraulic pressure clamping mechanism (not shown) of the clamping module 111, and the temperature was regulated by the temperature-regulating circuit (not shown).

In the injection charging, the injection speed was a speed of 100 m/s which was lower than the general injection speed. Accordingly, the metallic fine particles (Pd) are not dispersed at any sufficient concentration on the outermost surface of the polymer molded article. That is, the metallic fine particles (Pd) are dispersed at a concentration at which the plating reaction is not caused at the atmospheric pressure.

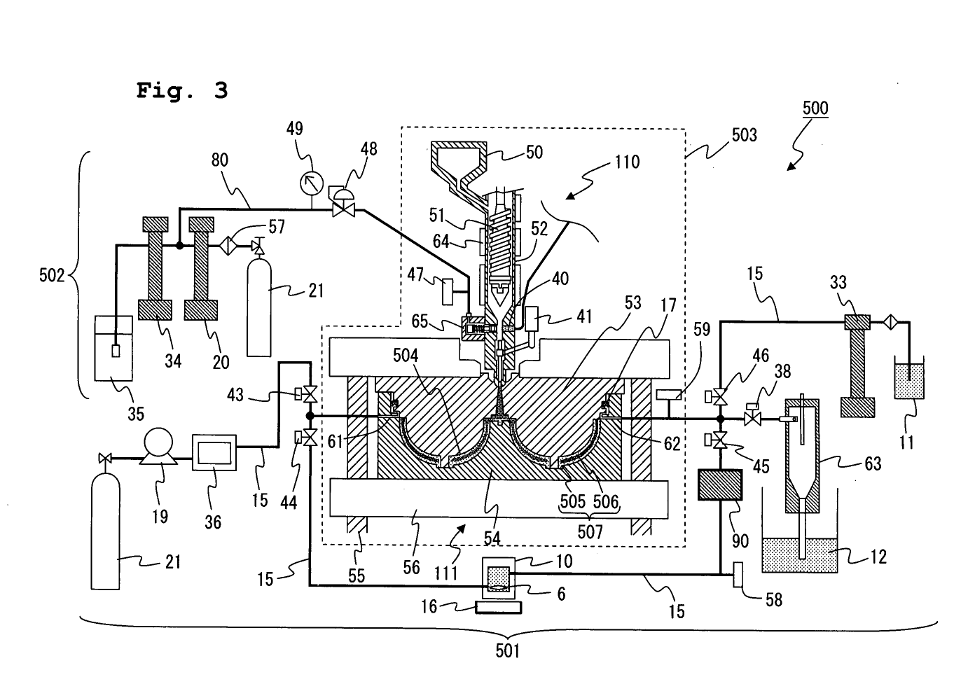

Subsequently, the molded article was cooled and solidified (state shown in FIG. 3).

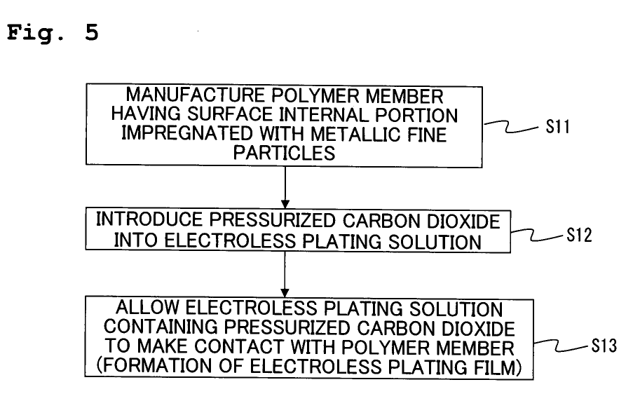

When the melted resin is injected and molded in the mold 53 and 54, the melted resin 68 of the flow front portion, which is firstly injected, forms the superficial skin of the injection molding article in accordance with the fountain effect (fountain flow effect). That is, in this embodiment, the metallic fine particles originating from the metal complex are dispersed in the vicinity of the flow front portion. Therefore, as shown in FIG. 3, the superficial skin (surface internal portion) 505 is impregnated with the metallic fine particles in the obtained polymer molded article 507 (Step S11 shown in FIG. 5). In this embodiment, the polymer molded article 507 was obtained in this way, in which the metallic fine particles were dispersed in the skin layer (surface internal portion) 505 as a superficial skin, and in which the metallic fine particles were scarcely present in the core layer 506 as an inner skin.

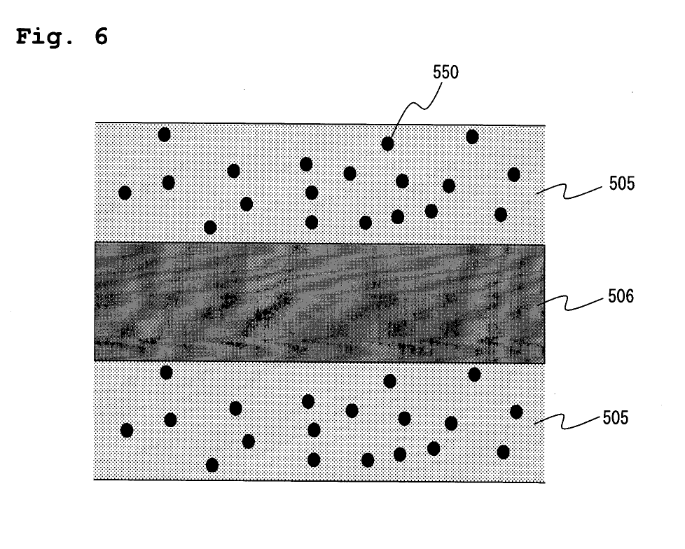

FIG. 6 shows a schematic cross section of the polymer molded article 507 of this embodiment manufactured as described above.

As shown in FIG. 6, the metallic fine particles 550 (metal substance) exist in the skin layer 505 of the polymer molded article 507 of this embodiment. The metal particles 550 are dispersed (allowed to exist) in the region ranging from the vicinity of the surface of the skin layer 505 (outermost surface of the surface internal portion) to the internal portion (inside portion of the surface internal portion). Further, the concentration of the metallic fine particles 550 in the vicinity of the outermost surface of the skin layer 505 was lower than the concentration of the metallic fine particles 550 at the internal portion (inside portion) of the skin layer 505.

The polymer molded article 507 (molded article shown in FIG. 6) immediately after the molding in this embodiment was actually immersed for 10 minutes in the electroless plating solution (plating solution having a plating reaction temperature of 60 to 85° C.) at 70° C. at the atmospheric pressure. As a result, any plating film was not formed on surface of the polymer molded article 507. According to this fact, it has been confirmed that the outermost surface (plating film-forming surface) of the polymer molded article 507 immediately after the molding in this embodiment is in the state in which the plating reaction is not caused at the atmospheric pressure, i.e., the outermost surface is inactive with respect to the electroless plating solution.

### Method for Forming Plating Film

The electroless plating treatment was performed in the mold 53 and 54 for the polymer molded article 507 which was manufactured as described above and in which the metallic fine particles were dispersed in the surface internal portion. The interior of the mold was temperature-regulated at 80° C. during the period in which the electroless plating treatment was performed.

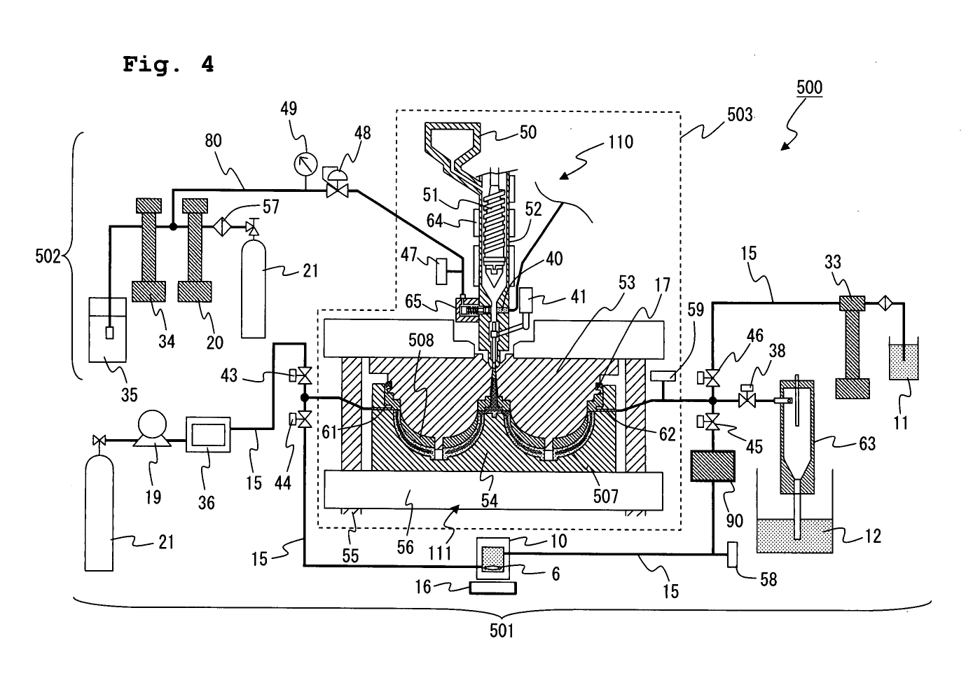

At first, as shown in FIG. 4, the hydraulic pressure clamping mechanism (not shown) of the clamping module 111 was moved backwardly (in the downward direction as viewed in FIG. 4). Accordingly, the movable platen 56 and the movable mold 54 were moved backwardly, and the gap 508 (cavity 508) was provided between the fixed mold 53 and the polymer molded article 507.

Subsequently, the electroless plating solution added with the pressurized carbon dioxide was introduced into the cavity 508, and the electroless plating solution was allowed to make contact with the polymer molded article 507. Specifically, the electroless plating solution added with the pressurized carbon dioxide was allowed to make contact with the polymer molded article 507 as follows.

At first, the electroless plating solution containing alcohol, which was supplied from the plating tank 11 of the electroless plating section 501, was previously mixed with the pressurized carbon dioxide at 15 MPa which was supplied from the buffer tank 36, in the high pressure container 10 at a ratio of 7:3 (Step S12 shown in FIG. 5). In the present invention, the mixing ratio of the pressurized carbon dioxide and the plating solution is preferably within a range of 1:9 to 5:5. In particular, it is desirable that the amount of the plating solution is increased. During this process, the stirrer 16 was driven, and the pressurized carbon dioxide and the electroless plating solution were compatibly dissolved with each other in the high pressure container 10 in accordance with the high speed rotation of the magnetic stirrer 6. Subsequently, the automatic valve 43 was closed, and the automatic valves 44, 45 were opened.

Subsequently, the circulation pump 90 was operated to circulate the electroless plating solution added with the pressurized carbon dioxide and alcohol in the circulation flow passage composed of the high pressure container 10, the piping 15, and the cavity 508. The electroless plating solution was allowed to temporarily stay and make contact with the surface of the polymer molded article 507. Accordingly, the plating film (nickel-phosphorus film) was formed on the surface of the polymer molded article 507 (Step S13 shown in FIG. 5).

During the period in which the electroless plating solution added with the pressurized carbon dioxide was circulated, both of the pressures of the cavity 508 and the circulation line 15 detected by the both pressure sensors 58, 59 were identical with each other. The electroless plating solution was supplemented at any time such that the plating solution, which was supplied from the plating tank 11, was allowed to have the pressure raised by the syringe pump 33 so that the plating solution was fed simultaneously with the opening of the automatic valve 46.

In the step as described above, when the electroless plating solution added with the pressurized carbon dioxide and alcohol is allowed to make contact with the polymer molded article 507, the plating reaction is not caused on the outermost surface of the polymer molded article 507. Therefore, the electroless plating solution added with the pressurized carbon dioxide is permeated until arrival at the internal portion (inside portion) of the polymer molded article 507.

The area, in which the metallic fine particles are dispersed at the concentration sufficient to cause the plating reaction, is present in the internal portion (inside portion) of the polymer molded article 507. Therefore, when the electroless plating solution is permeated to arrive at the area, the growth of the plating film is started by using the metallic fine particles in the area as the catalyst cores.

After that, the plating film grows from the internal portion (inside portion) of the polymer member toward the surface (outermost surface) in accordance with the autocatalytic action of the metallic fine particles. That is, the plating film, which is formed on the polymer molded article 507, grows in such a state that the plating film bites into the internal portion of the polymer molded article 507, which is excellent in the adhesion performance.

Subsequently, after the plating film was formed on the polymer molded article 507 as described above, the electroless plating solution added with the pressurized carbon dioxide was discharged to the recovery tank 12 via the recovery container 63 from the circulation passage of the electroless plating solution added with the pressurized carbon dioxide. Specifically, the automatic valves 44, 45 are closed, and the automatic valve 38 was subsequently opened. Accordingly, the electroless plating solution added with the pressurized carbon dioxide is discharged to the recovery container 63. The recovery container 63 separates the recovered electroless plating solution added with the pressurized carbon dioxide into the aqueous solution (plating solution) and the high pressure gas (carbon dioxide) in accordance with the principle of centrifugation. The plating solution is recovered by the recovery tank 12, which can be reused. The gasified carbon dioxide was discharged from the upper portion of the recovery container 63, which is recovered by an unillustrated gas discharge duct.

Subsequently, the automatic valve 43 is opened for a certain period of time to introduce the pressurized carbon dioxide into the gap 508 (cavity 508) between the fixed mold 53 and the polymer molded article 507. Accordingly, the remaining matter of the plating solution, which remains in the cavity 508, is discharged to the outside of the mold 53 and 54 together with the pressurized carbon dioxide. Subsequently, the mold 53 and 54 was opened at the point of time at which the internal pressure of the cavity 508 was zero as the monitored value obtained by the pressure sensor 59, and the polymer molded article 507 was taken out.

Subsequently, the ordinary silver plating was applied to the taken out polymer molded article 507 to stack a silver plating film on the surface of the polymer molded article 507. In this embodiment, the polymer molded article 507, which had the plating film formed on the surface, was obtained as described above.

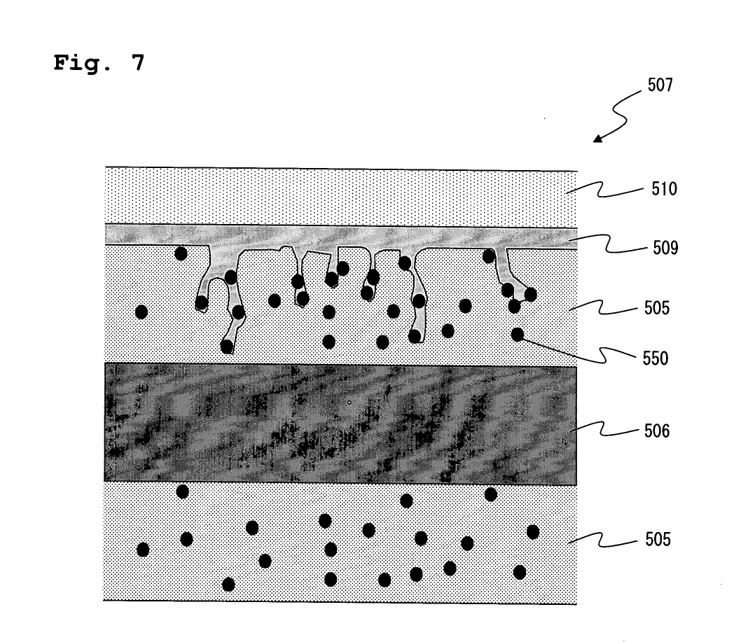

FIG. 7 shows a schematic cross section of a part of the polymer molded article 507 manufactured in this embodiment. The metal film 509 (plating film) of nickel-phosphorus, which was allowed to grow in the mold 53 and 54, was formed on one side of the polymer molded article 507 manufactured in this embodiment. The metal film 509 of nickel-phosphorus grew from the internal portion of the polymer molded article 507 (permeating or impregnating layer of the metal film 509 was formed). The high reflective film 510 of silver was formed on the metal film 509 of nickel-phosphorus.

### Evaluation of Plating Film

Subsequently, the adhesion performance of the metal film was evaluated for the polymer molded article 507 manufactured in this embodiment. Specifically, a high temperature high humidity test (condition: temperature of 85° C., humidity of 85% Rh, leaving time of 1,000 hours), a high temperature test under a condition of a temperature of 150° C. and a leaving time of 500 hours, and a heat shock test to switch the temperature between −30° C. and 150° C. in 20 cycles were carried out. As a result, any deterioration of the adhesion performance of the metal film was not observed in all of the tests.

The surface roughness Ra of the polymer molded article 507 manufactured in this embodiment was measured. As a result, the surface roughness was Ra=100 nm which was equivalent to the surface roughness of the mold 53 and 54.

As described above, according to the method for forming the plating film of this embodiment, the plating treatment can be performed simultaneously with the injection molding. Therefore, the process can be simplified, and the polymer member can be produced economically. Further, the resin material having the high heat resistance can be molded, and the metal film can be formed on the molded article. Therefore, it has been revealed that the metal film, which has a high adhesion performance and a smooth surface, can be formed on the molded article having the high heat resistance.

### Second Embodiment

In this second embodiment, an explanation will be made about a method in which a polymer molded article having a surface internal portion impregnated with metallic fine particles is manufactured by using a sandwich molding machine, and then the electroless plating treatment of the molded polymer article is executed in a separated container. In this embodiment, a door knob for an automobile was manufactured as the polymer molded article.

The type of the functional material to be dissolved in the pressurized carbon dioxide is arbitrary. However, in this embodiment, the metal complex was used. The type of the metal complex is also arbitrary. However, hexafluoroacetyl-acetonato palladium (II) having a high solubility in carbon dioxide was used. The condition of the temperature and the pressure of the pressurized carbon dioxide to be introduced into the melted resin are arbitrary. However, the temperature was 40° C. and the pressure was 10 MPa to provide the supercritical state in this embodiment. Further, in this embodiment, polyamide 6 resin containing 30% glass fiber was used as a material for forming the polymer molded article.

### Sandwich Molding Machine

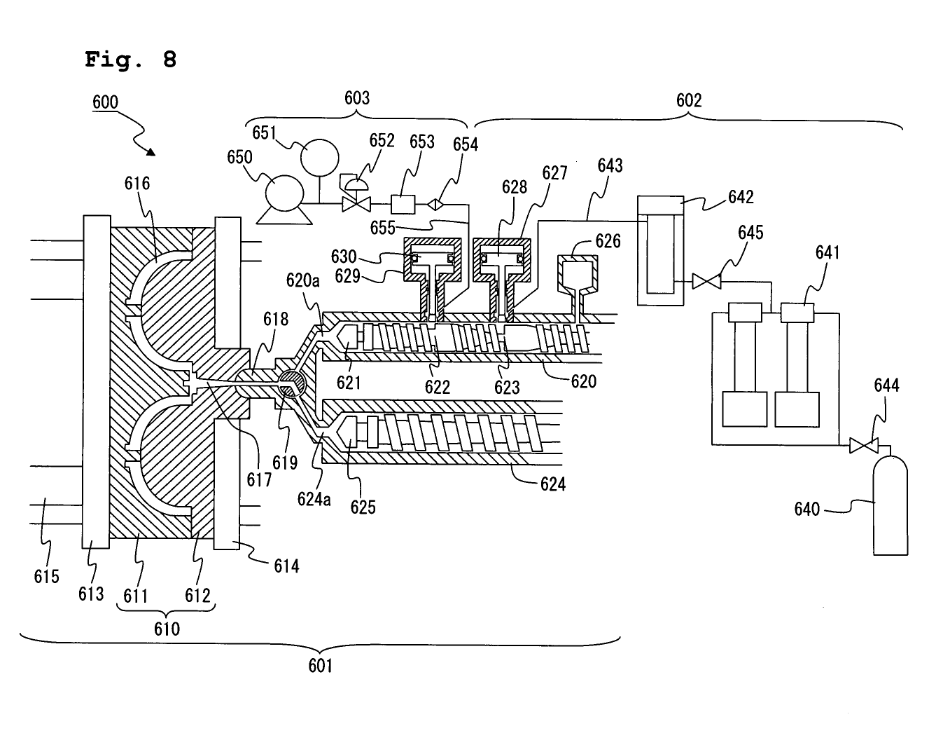

At first, an explanation will be made about the sandwich molding machine used in the method for producing the polymer molded article (polymer member) in this embodiment. FIG. 8 shows a schematic arrangement of the molding machine used in this embodiment. The molding machine 600 used in this embodiment comprises a sandwich molding machine section 601, a pressurized fluid supply section 602, and a pressurized fluid discharge section 603.

As shown in FIG. 8, the sandwich molding machine section 601 principally includes a first plasticizing and melting cylinder 620 (hereinafter referred to as “first heating cylinder” as well) which is provided to form the outer skin (surface layer) of the polymer molded article, a second plasticizing and melting cylinder 624 (hereinafter referred to as “second heating cylinder” as well) which is provided to form the core portion of the polymer molded article, a nozzle section 618 which is connected to melted resin discharge ports 620a, 624a of the first heating cylinder 620 and the second heating cylinder 624 and which is communicated with inner portions of the first heating cylinder 620 and the second heating cylinder 624, and a mold 610 which is provided with a movable mold 611 and a fixed mold 612.

As shown in FIG. 8, in the nozzle section 618, a rotary valve 619 is provided, which is provided to switch the injection passage for the melted resin to be injected into the mold 610. In this embodiment, as described later on, by rotating the rotary valve 619, it is possible to switch an injection passage to the cavity 616 in the mold 610 between the injection passage for the melted resin ranging from the interior of the first heating cylinder 620 and the injection passage for the melted resin ranging from the interior of the second heating cylinder 624.

The cavity 616 of the mold 610 is the internal space which is defined by the abutment of the fixed mold 612 and the movable mold 611. In this embodiment, as shown in FIG. 8, the mold 610 was used to mold two automobile door knobs simultaneously at the symmetric position of a spool 617. The fixed mold 612 is fixed to a fixed platen 614, the movable mold 611 is fixed to a movable platen 613, and the movable platen 613 is driven along a clamping mechanism 615. In FIG. 8, the movable mold 611 abuts against the fixed mold 612, and the mold 610 is closed.

In this embodiment, as shown in FIG. 8, the first heating cylinder 620 is provided with an introducing cylinder 627 and a discharge cylinder 629. The introducing cylinder 627 adopts the air driving system in which an introducing piston 628 is provided therein. The introducing cylinder 627 is used in order that the supercritical carbon dioxide dissolved with the metal complex is introduced into the melted resin contained in the first heating cylinder 620. The discharge cylinder 629 adopts the air driving system in which a discharge piston 630 is provided therein. The discharge cylinder 629 is used in order that the supercritical carbon dioxide is discharged from the melted resin.

In this embodiment, as shown in FIG. 8, bent sections are provided at two positions to reduce the internal pressure of the resin, for a screw 621 (hereinafter referred to as “first screw”) disposed in the first heating cylinder 620. The first bent section 623 and the second bent section 622 are shown in FIG. 8. The introducing cylinder 627 and the discharge cylinder 629 are provided in the vicinity of the first bent section 623 and the second bent section 622 respectively. As described above, the molding machine of this embodiment is provided with the mechanism which gasifies the supercritical carbon dioxide permeated into the melted resin to discharge the supercritical carbon dioxide before the injection and charging.

On the other hand, the second heating cylinder 624 has the same structure as that of the conventional heating cylinder.

As shown in FIG. 8, the pressurized fluid supply section 602 principally includes a liquid carbon dioxide bottle 640, a known syringe pump 641, and a dissolving tank 642 in which the metal complex is dissolved in the supercritical carbon dioxide. These constitutive components are connected to one another by means of a piping 643. As shown in FIG. 8, valves 644, 645, which are provided to control the flow of the supercritical carbon dioxide, are installed for the piping 643 disposed between the liquid carbon dioxide bottle 640 and syringe pump 641 and the piping 643 disposed between the syringe pump 641 and the dissolving tank 642. The dissolving tank 642 is connected via the piping 643 to the introducing cylinder 627 of the sandwich molding machine section 601.

As shown in FIG. 8, the pressurized fluid discharge section 603 principally includes a filter 654, a buffer container 653, a pressure-reducing valve 652, and a vacuum pump 650. These respective constitutive components are connected to one another by means of a piping 655. The filter 654 is connected via the piping 655 to the discharge cylinder 629 of the sandwich molding machine section 601.

The molding machine usable in this embodiment is not limited to the example shown in FIG. 8. Any molding machine having any arbitrary structure is usable, provided that the molding machine has the first plasticizing cylinder for forming the outer skin of the polymer molded article and the second plasticizing cylinder for forming the inner skin, and the molding machine has the function to introduce the pressurized carbon dioxide and the functional material (metal complex) dissolved therein into at least the first plasticizing cylinder.

### Method for Producing Polymer Molded Article and Method for Forming Plating Film

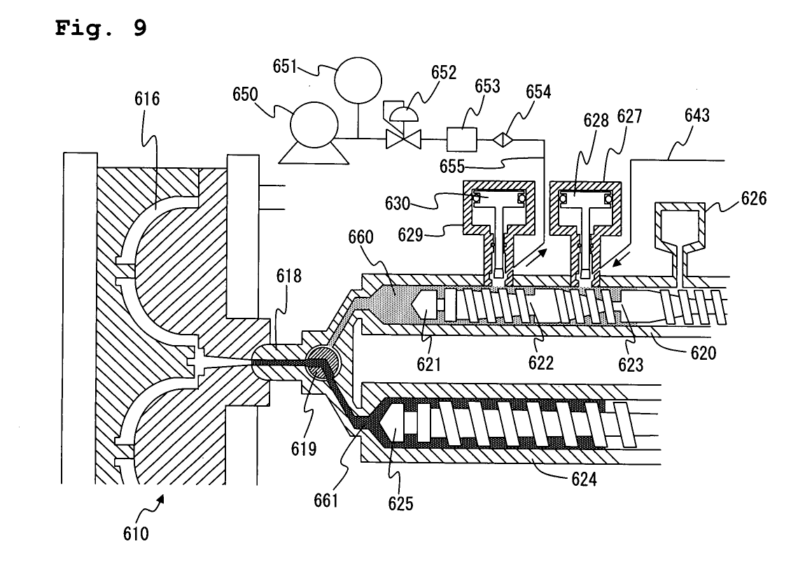

Next, an explanation will be made with reference to FIGS. 8 to 15 about a method for producing the polymer molded article of this embodiment. FIGS. 9 to 15 explain the procedure for the method for producing the polymer base member in the second embodiment. In this embodiment, the method for producing the polymer molded article is explained at the time when the previous sandwich molding is completed, i.e., at the time when the sandwich molding performed on the last occasion is completed (state shown in FIG. 9). Therefore, in FIG. 9, the melted resin, which has been injected from the second heating cylinder 624 during the previous molding, remains in the flow passage for the resin in the nozzle section 618.

At first, an explanation will be made about a method for dissolving the metal complex in the supercritical carbon dioxide. The valve 644 was opened, and the carbon dioxide was supplied from the liquid carbon dioxide bottle 640 to the syringe pump 641. The syringe pump 641 raises the pressure of the supplied carbon dioxide to a predetermined pressure (10 MPa).

Subsequently, the valve 645 was opened, and the pressurized liquid carbon dioxide was introduced into the dissolving tank 642 to dissolve the metal complex in the pressurized carbon dioxide (Step S21 shown in FIG. 15). During this process, the dissolving tank 642 was previously heated to retain the temperature at 40° C. Accordingly, the pressurized liquid carbon dioxide introduced into the dissolving tank 642 is allowed to be in the supercritical state. When the supercritical carbon dioxide was introduced into the dissolving tank 642, the piping area ranging to the introducing cylinder 627 was also pressurized by the supercritical carbon dioxide. In this embodiment, the metal complex was previously charged in the dissolving tank 642 and the inside of the tank 642 is in the supersaturating state by the metal complex.

The area, which ranges from the dissolving tank 642 to the introducing cylinder 627, is retained at the constant pressure by being controlled by the syringe pump 641, except when the supercritical carbon dioxide and the organic metal complex are introduced into the first heating cylinder 620 in the plasticizing and weighing step as described later on.

Subsequently, the resin pellets (not shown) in a sufficient amount were supplied from the hopper 626 into the first heating cylinder 620. The pellets (first thermoplastic resin: polyamide 6 resin) were plasticized and melted in accordance with the rotation of the first screw 621. During the plasticizing and weighing, the first screw 621 intends to extrude the melted resin in front of the screw in accordance with the rotation thereof. Therefore, the internal pressure in front of the screw is raised, and the first screw 621 is moved backwardly. During the backward movement, the melted first thermoplastic resin (hereinafter referred to as “first melted resin” as well) is subjected to the pressure reduction (about 7 MPa) at the first bent section 623 of the first screw 621. That is, at a position under the introducing cylinder 627, the pressure of the thermoplastic resin is reduced.

In the state in which the first melted resin is subjected to the pressure reduction, as shown in FIG. 9, the introducing piston 628 in the introducing cylinder 627 is moved upwardly. Accordingly, the dissolving tank 642 of the pressurized fluid supply section 602 is communicated with the interior of the first heating cylinder 620. The supercritical carbon dioxide, in which the metal complex is dissolved, is introduced into the first heating cylinder 620, which is permeated into the first melted resin (Step S22 shown in FIG. 15). During the permeating step, the syringe pump 641 is switched into the flow rate control. Therefore, the supercritical carbon dioxide at a constant flow rate was successfully injected into the first heating cylinder 620 for a certain period of time. A greater part of the metal complex, with which the first melted resin is impregnated, is reduced, for example, by the heat of the first melted resin and so on, and the metal complex is converted into the plating catalyst (metallic fine particles).

In this embodiment, the supercritical carbon dioxide, which was permeated into the first melted resin during the plasticizing and weighing, was gasified, and the supercritical carbon dioxide was discharged via the discharge cylinder 629 from the interior of the first heating cylinder 620 to the pressurized fluid discharge section 603. Specifically, the supercritical carbon dioxide was discharged as follows.

At first, the first melted resin is subjected to the pressure reduction at the second bent section 622 of the first screw 621 during the plasticizing and weighing. Accordingly, the supercritical carbon dioxide, which was permeated into the melted resin, was subjected to the pressure reduction to have the pressure of not more than the critical pressure, and the supercritical carbon dioxide was gasified.

As shown in FIG. 9, the gas discharge piston 630 provided in the discharge cylinder 629 is moved upwardly. Accordingly, the first heating cylinder 620 is communicated with the pressurized fluid discharge section 603. A part of carbon dioxide, which was gasified at the second bent section 622 in the first heating cylinder 620, was discharged to the pressurized fluid discharge section 603 via the discharge cylinder 629.

The metal complex is a sublimation type. Thus, the metal complex is kneaded in the high temperature resin and then changed into the metallic fine particles by the thermal decomposition as described before. Then, the metal complex is in the state of being insoluble in carbon dioxide. Therefore, the metal complex is not discharged together with the carbon dioxide.

In this embodiment, the staying time of the metallic fine particles was prolonged (specifically about 50 seconds) in the high temperature resin. The metallic fine particles, which had the large specific gravity owing to the thermal reduction, were dispersed in the melted resin. When the state as described above is provided, the metallic fine particles are hardly dispersed (hardly allowed to float) on the outermost surface of the polymer molded article (skin layer) during the injection charging as described later on.

The carbon dioxide, which was discharged to the high pressure fluid discharge section 603, was allowed to pass through the filter 654 and the buffer container 653. After that, the carbon dioxide was subjected to the pressure reduction by the pressure-reducing valve 652 so that the pressure gauge 651 indicated 0 MPa. The carbon dioxide was discharged by the vacuum pump 650. In this embodiment, the first melted resin was impregnated with the metal complex after the metal complex was modified into the metallic fine particles, and the supercritical carbon dioxide was gasified and discharged from the first melted resin, while performing the plasticizing and weighing for the first thermoplastic resin in the first heating cylinder 620 as described above.

During the plasticizing and weighing step for the first thermoplastic resin in the first heating cylinder 620 as described above, the resin pellets, which are supplied from the hopper 626, are plasticized and melted while being kneaded with the introduced supercritical carbon dioxide and the metal complex. Therefore, in the first melted resin, both of the supercritical carbon dioxide and the metal complex are homogeneously or uniformly dispersed.

During the plasticizing and weighing in the first heating cylinder 620, as shown in FIG. 9, the rotation of the rotary valve 619 is adjusted so that the interior of the second heating cylinder 624 is communicated with the injection flow passage in the nozzle section 618 via the flow passage in the rotary valve 619. Therefore, the interior of the first heating cylinder 620 is not communicated with the interior of the nozzle section 618. Further, the first melted resin, which is pressurized in the first heating cylinder 620, does not leak from the forward end of the nozzle section 618 into the mold 610.

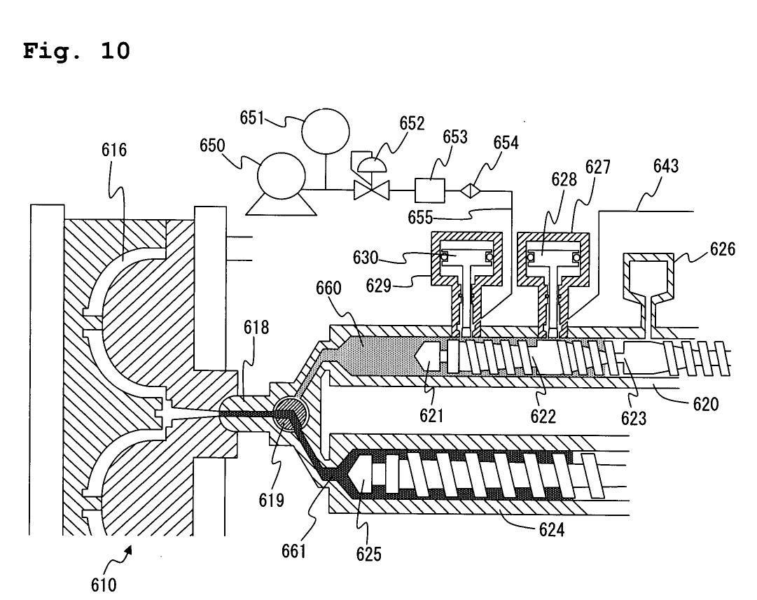

At the point of time at which the plasticizing and weighing is completed for the first melted resin 660 impregnated with the metallic fine particles (and the metal complex) in the first screw 621, as shown in FIG. 10, the introducing piston 628 in the introducing cylinder 627 and the discharge piston 630 in the discharge cylinder 629 are moved downwardly to stop the introduction and the discharge of the pressurized carbon dioxide. Simultaneously, the syringe pump 641 was switched from the flow rate control to the pressure control.

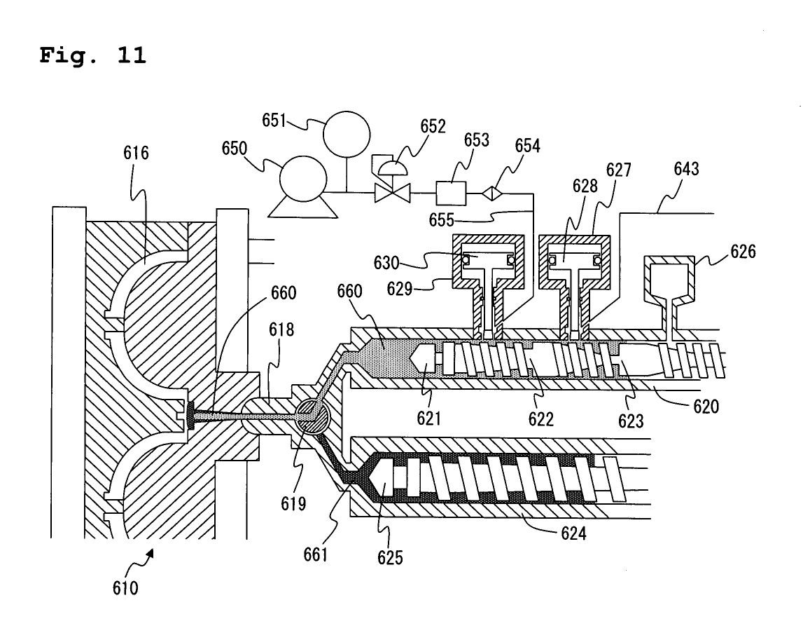

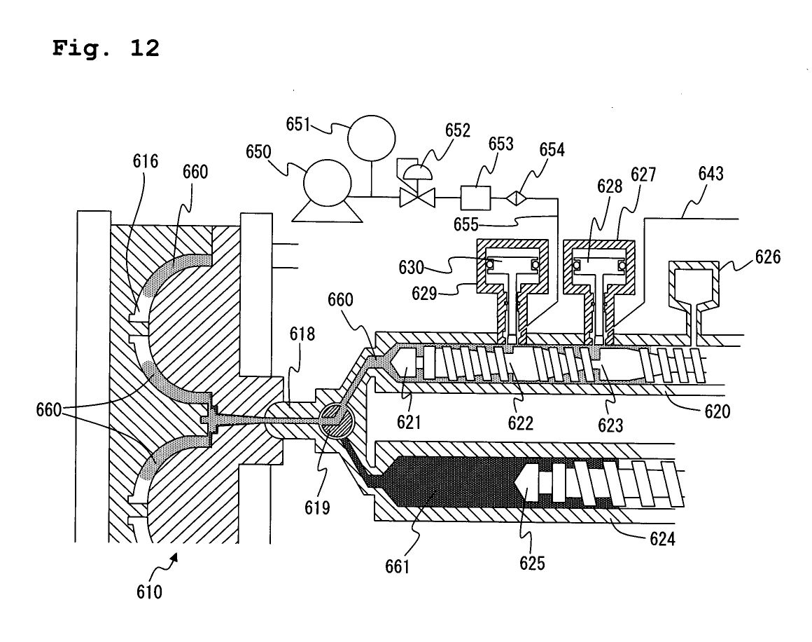

Subsequently, as shown in FIG. 11, the rotary valve 619 was rotated so that the interior of the first heating cylinder 620 was communicated with the injection passage in the nozzle section 618, i.e., the interior of the first heating cylinder 620 was communicated with the cavity 616 in the mold 610. Subsequently, the first screw 621 in the first heating cylinder 620 was moved frontwardly, and the plasticized and weighed first melted resin 660 was injected into the spool and the cavity 616 in the mold 610 (Step S23 shown in FIG. 15, states shown in FIGS. 11 and 12). The state shown in FIG. 12 shows the state brought about immediately before the completion of the injection and charging of the first melted resin 660. As shown in FIG. 12, in this embodiment, the amount of the first melted resin 660 to be injected was adjusted to an amount of such an extent that the entire interior of the cavity 616 was not filled therewith.

During the injection of the first melted resin, in the second heating cylinder 624, the resin pellets (second thermoplastic resin: polyamide 6 resin) were supplied from the unillustrated hopper into the second heating cylinder 624 to perform the plasticizing and weighing in accordance with the rotation of the second screw 625. During this process, in the second heating cylinder 624, the resin pellets were plasticized and melted without introducing the metal complex (the resin plasticized and melted in the second heating cylinder 624 will be hereinafter referred to as “second melted resin” as well). The plasticizing and weighing of the second melted resin 661 was completed immediately before the injection and charging of the first melted resin 660 was completed (state shown in FIG. 12). In this embodiment, the same material was used for the first thermoplastic resin and the second thermoplastic resin. However, the present invention is not limited thereto. Different materials may be also used for the first thermoplastic resin and the second thermoplastic resin.

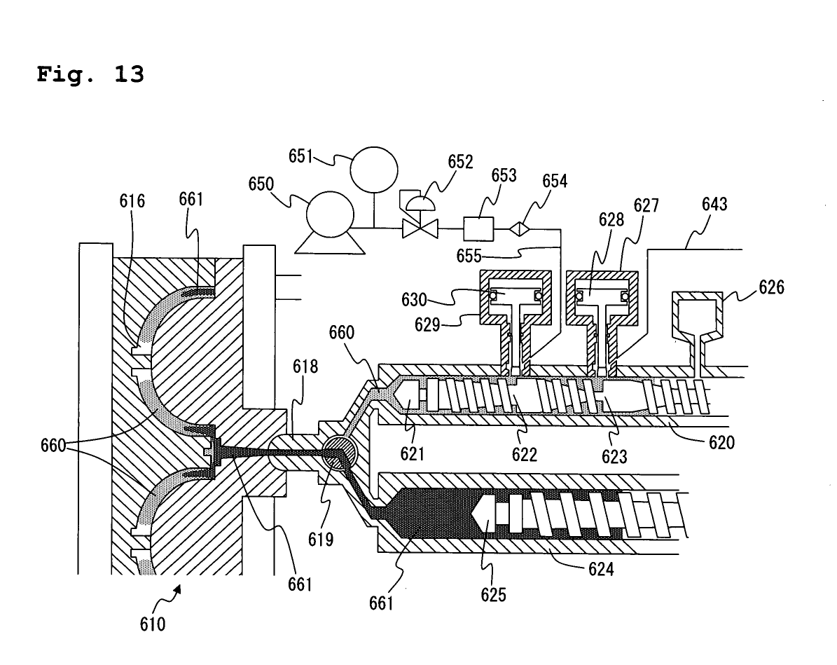

Subsequently, after the injection and charging of the first melted resin 660 was completed, as shown in FIG. 13, the rotary valve 619 was rotated to make communication between the interior of the second heating cylinder 624 and the injection passage in the nozzle section 618. Subsequently, the second screw 625 was moved frontwardly, and the second melted resin 661 was injected into the spool and the cavity 616 in the mold 610 (Step S24 shown in FIG. 15, state shown in FIG. 13). In this situation, the first melted resin 660, which has been previously charged in the cavity 616, is excluded or extruded to be moved toward the mold surface for defining the cavity 616 in accordance with the charging pressure of the second melted resin 661.

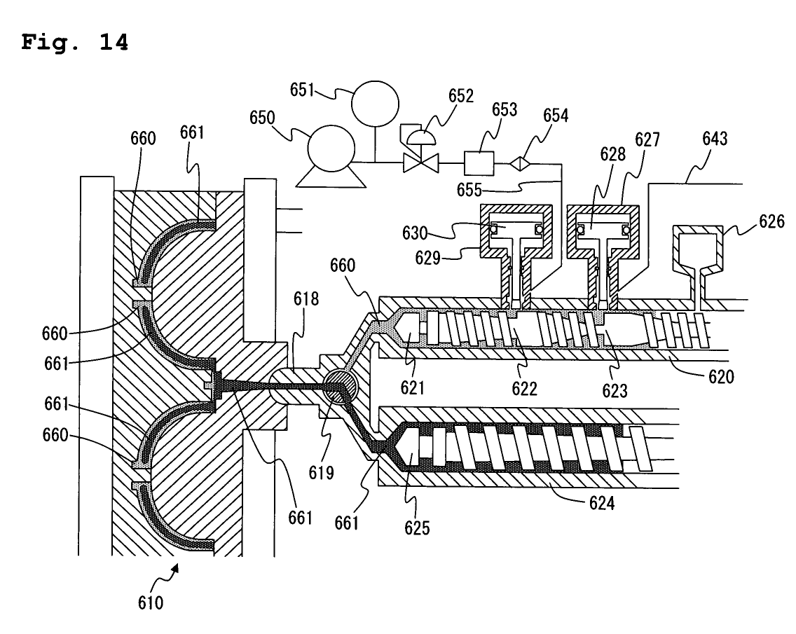

As a result, as shown in FIG. 14, the layer of the first melted resin 660, in which the metallic fine particles (and the metal complex) are dispersed, is formed at the surface layer (outer skin) of the molded article, after the completion of the injection of the second melted resin 661. The core portion, which is composed of the second melted resin 661 not containing the metallic fine particles, is formed at the inside of the molded article.

Subsequently, the injected and charged melted resin was cooled and solidified, and then the mold 610 was opened to take out the molded article (polymer base member). In this embodiment, the polymer molded article, in which the metallic fine particles were dispersed in the surface internal portion, was obtained in accordance with the sandwich molding as described above.

The polymer molded article of this embodiment molded as described above was immersed for 10 minutes in the electroless plating solution (plating solution having a plating reaction temperature of 60 to 85° C.) at 70° C. at the atmospheric pressure in the same manner as in the first embodiment. However, the plating film was not formed on the surface of the polymer molded article. That is, in relation to the polymer molded article molded by means of the molding method of this embodiment as described above, the following fact has been confirmed. That is, the concentration of the metallic fine particles is low at the outermost surface (surface layer), and the outermost surface of the polymer molded article is in the state in which the plating reaction is not caused at the atmospheric pressure, i.e., the outermost surface of the polymer molded article is inactive with respect to the electroless plating solution.

Subsequently, a plating film was formed by means of a new electroless plating method on the surface of the polymer molded article of this embodiment molded as described above (Step 25 shown in FIG. 15). Specifically, the plating film was formed on the surface of the polymer molded article as follows.

At first, a high pressure container, which is provided with an unillustrated inner container made of PTFE (polytetrafluoroethylene), is prepared. A nickel-phosphorus plating solution, which is composed of 15% undiluted solution, 50% alcohol (propanol), and 35% water, is poured into the inner container. Subsequently, the polymer molded article was introduced into the inner container to immerse the polymer molded article in the electroless plating solution. In this procedure, the electroless plating solution, the high pressure container, and the inner container were previously heated to a temperature of 70° C.

Subsequently, the pressurized carbon dioxide at 20° C. and 15 MPa was introduced into the high pressure container and the inner container, and the pressurized carbon dioxide was compatibly dissolved in the electroless plating solution. Accordingly, the electroless plating solution added with the pressurized carbon dioxide was allowed to make contact with the polymer molded article. The contact state was maintained for 5 minutes, the pressure was reduced, and the polymer molded article was taken out from the inner container.

As a result, the metal film of nickel-phosphorus was formed on the entire surface of the polymer molded article.

Also in this new electroless plating method, the plating reaction is not caused on the outermost surface (surface layer) of the polymer molded article. The electroless plating solution added with the pressurized carbon dioxide is permeated into the internal portion (inside or inner layer) of the polymer molded article. When the electroless plating solution is permeated to arrive at the area in which the metallic fine particles are dispersed at the concentration sufficient to cause the plating reaction in the internal portion (inside layer) of the polymer molded article, the plating film starts the growth by using the catalyst cores of the metallic fine particles existing in the area. After that, the plating film grows from the internal portion (inside layer) of the polymer molded article toward the surface in accordance with the autocatalytic action of the metallic fine particles. That is, also in this embodiment, the plating film, which is formed on the polymer molded article, grows in the state in which the plating film bites into the internal portion of the polymer molded article. Therefore, the adhesion performance is excellent.

Subsequently, an electroplating copper film was formed to have a thickness of 20 μm by means of the conventional electroplating method on the surface of the polymer molded article having been subjected to the electroless plating treatment as described above (metal film of nickel-phosphorus was formed on the surface). Further, a bright electroplating nickel film was formed thereon to have a thickness of 10 μm.

The evaluation tests were also performed for the adhesion performance of the metal film in relation to the polymer molded article having the metal film formed on the surface manufactured in this embodiment, in the same manner as in the first embodiment. As a result, any exfoliation of the metal film was not observed, and any deterioration of the adhesion performance was not recognized.

### Third Embodiment

In this third embodiment, the composition of the electroless plating solution was changed in the electroless plating treatment as performed in the second embodiment. Specifically, various electroless plating solutions were prepared, in which the volume ratio of alcohol in the electroless plating solution (nickel-phosphorus plating solution) was 10, 30, 60, and 80%. Other than the above, the electroless plating film was formed on the surface of the polymer molded article (polymer member) in the same manner as in the second embodiment. In this embodiment, each of the electroless plating solutions was continuously used for the plating treatment performed a plurality of times.

As a result of the treatment as described above, in the case of the electroless plating solution in which the volume ratio of alcohol was 80%, the plating film was formed on the entire surface of the polymer molded article in the treatment performed for the first time, but the plating film was scarcely formed in the treatment performed for the second time, probably for the following reason. That is, it is considered that nickel sulfate tends to be deposited from the nickel-phosphorus plating solution, when the amount of addition of alcohol is large. As a result, it is considered that the amount of nickel sulfate ion in the plating solution is insufficient in the treatment performed for the second time, and the plating bath is destroyed. In the case of the electroless plating solution in which the volume ratio of alcohol was 80%, the deposited matter of nickel sulfite was actually confirmed in the plating solution in the treatments performed for the first time and the second time. However, as described above, in the case of the electroless plating solution in which the volume ratio of alcohol is 80%, it has been revealed that the plating treatment can be performed at least once, although nickel sulfite is consequently deposited in the plating solution.

In the case of the electroless plating solution in which the volume ratio of alcohol was 60%, the plating film was successfully formed on the entire surface of the polymer molded article in the treatment performed for the second time and the followings as well, in the same manner as in the treatment performed for the first time. When the volume ratio of alcohol was 60%, the plating treatment time, which is required for each one of the periods of the plating treatments (for each one of the periods required to form each of the plating film on each of the entire surface of the polymer molded article), was 3 minutes.

In the case of the electroless plating solution in which the volume ratio of alcohol was 30%, the plating treatment time, which is required for one time of the plating treatment, was prolonged to be 10 minutes. In the case of the electroless plating solution in which the volume ratio of alcohol was 10%, the plating treatment time, which is required for one time of the plating treatment, was further prolonged to be 30 minutes, probably for the following reason. That is, it is considered that the surface tension of the electroless plating solution is increased when the amount of alcohol is decreased, and a long period of time is required to permeate the electroless plating solution into the polymer molded article. When the volume ratio of alcohol was 10, 30, and 60%, the plating film was successfully formed on the entire surface of the polymer molded article in any case in the plating treatment performed for the second time and the followings as well.

Further, for the purpose of comparison, the electroless plating solutions were prepared, in which the volume ratio of alcohol was 5 and 90% respectively. The plating treatment was performed for the polymer molded article with each of the electroless plating solutions in the same manner as described above. As a result, when the volume ratio of alcohol was 5%, the plating film was formed on only a part of the surface of the polymer molded article, even when the plating treatment time was prolonged to be 1 hour. On the other hand, when the volume ratio of alcohol was 90%, then almost all of nickel sulfate was precipitated, and the plating film was not formed.

### Fourth Embodiment

In this fourth embodiment, as the material for forming the polymer molded article (polymer member), a resin material of polyphenylene sulfide was used, in which fine particles of calcium carbonate (mineral) were previously mixed. Calcium carbonate is the substance (elutable substance) which is to be dissolved in and extracted with the mixture solvent of the pressurized carbon dioxide and the plating solution. The polymer molded article was molded by means of the injection molding in the same manner as in the first embodiment except that the material for forming the polymer molded article was changed. After that, the plating treatment was performed in the mold 53 and 54 used for the molding, and the plating film was formed on the polymer molded article.

In this embodiment, after both of the electroless plating treatment process and the discharging process of remaining plating solution from the mold 53 and 54 using clean pressurized carbon dioxide, a clamping pressure of 100 tons was applied to the molded article as the pressure of carbon dioxide was reduced. The object thereof is, for example, to remove a larger amount of the mixture solution of the pressurized carbon dioxide and the plating solution from the interior of the polymer, to improve the physical strength by pressing and solidifying the swelled polymer molded article, and to correct the deformation of the polymer. The pressing step after the plating may be performed in the mold 53 and 54, or the pressing step may be performed in a separated batch process article. Alternatively, the pressing step may be performed after releasing the pressure after the plating reaction. When the clamping step is added as described above, the method for forming the plating film of the present invention can be also applied to the molded article of, for example, the amorphous or non-crystalline thermoplastic resin in which the deformation is considerably caused due to the swelling.

When the substance, which is to be dissolved in or extracted with the mixture solution of the pressurized carbon dioxide, the plating solution or water, and alcohol, is previously blended in the resin material as in this embodiment, the polymer molded article, in which the elutable substance is dispersed in the internal portion, can be obtained as the polymer molded article. When the mixture solution is allowed to make contact with the polymer molded article, the mixture solution is easily permeated into the internal portion of the polymer molded article via holes or vacancies where the elutable substance has been removed. Those usable as the elutable substance as described above include, for example, water-soluble materials such as polyethylene glycol and surfactants, amorphous or non-crystalline thermoplastic resin components, and various elastomers.

In the case of the polymer molded article in which the elutable substance is dispersed in the internal portion as in this embodiment, when the elutable substance, which has been dispersed in the outermost surface, is eluted in the electroless plating solution, the irregularities are formed on the surface of the polymer molded article. Therefore, the physical anchoring effect of the metal film is enhanced on the surface of the polymer molded article, and it is possible to improve the adhesion force of the metal film.

In order to obtain the effect in the polymer molded article of the present invention as described above, it is desirable that the elutable substance is dispersed in a depth area at least within 5 μm and more desirably within 1 μm from the outermost surface of the polymer molded article. In this embodiment, the calcium carbonate fine particles were dispersed at the high concentration in the area until arrival at a depth of about 0.5 μm from the outermost surface of the polymer molded article. The depth of impregnation of the elutable substance of the polymer molded article is adjustable depending on, for example, the particle size of the elutable substance and the presence or absence of the chemical modification applied to the elutable substance. Specifically, when the elutable substance is made into fine grains or particles or when the elutable substance is chemically modified to improve the compatibility with the resin, then the elutable substance is easily dispersed in the surface of the molded article during the injection molding.

In this embodiment, the elutable substance is eluted during the plating treatment. However, the process for eluting the elutable substance may be executed in a batch process to be performed before the plating treatment. Also in this modified case, it is appropriate that the elutable substance is dissolved or extracted in the solution which contains at least one of water, alcohol, and pressurized carbon dioxide.

In the method for forming the plating film of this embodiment, the reaction time (plating treatment time), in which the plating thin film is applied to the entire surface of the molded article, is greatly shortened. Specifically, the plating treatment time was 2 minutes when calcium carbonate was not dispersed in the internal portion of the polymer molded article. However, the plating treatment time was 1 minute in the method of this embodiment, probably for the following reason. That is, it is considered that the electroless plating solution is quickly permeated into the resin as dissolving the calcium carbonate contained in the resin, and the electroless plating solution is quickly reacted with the catalyst cores.

Further, the adhesion strength between the plating film and the polymer was improved by pressing the polymer molded article after the plating treatment as in the treatment method of this embodiment. Specifically, the adhesion strength between the plating film and the polymer was 0.9 kgf/cm when the press molding was not performed. However, the adhesion strength was 1.3 kgf/cm when the press molding was performed.

The first to fourth embodiments described above are illustrative of the case in which the crystalline material is used as the material for forming the polymer member (polymer molded article). However, the present invention is not limited thereto. The same or equivalent effect is also obtained even when any amorphous or non-crystalline material is used as the material for forming the polymer member (polymer molded article).

In the first to fourth embodiments of the present invention, the concentration of the metallic fine particles (metal substance) of the plating film-forming surface of the polymer molded article (polymer member) is adjusted by means of the molding condition of the injection molding. However, the present invention is not limited thereto.

For example, the following procedure is also available. That is, at first, the polymer molded article (polymer member, polymer base member) is molded, in which the metallic fine particles also exist in the outermost surface (surface layer) at the concentration to such an extent that the electroless plating reaction is caused at the atmospheric pressure. Subsequently, the polymer molded article (polymer member, polymer base member) is washed with acid including, for example, nitric acid, hydrochloric acid, and aqua regia to remove only the metallic fine particles existing at the outermost surface, and thus the concentration of the metallic fine particles at the plating film-forming surface is adjusted.

Another method is also available. That is, the polymer molded article (polymer base member) is manufactured, in which the metallic fine particles exist in the outermost surface at the concentration to such an extent that the electroless plating reaction is caused at the atmospheric pressure. Subsequently, the film, which is composed of a material (for example, the same material as that of the polymer molded article) capable of allowing the electroless plating solution added with the pressurized carbon dioxide to pass therethrough, is formed on the polymer molded article (polymer base member). In the case of this polymer molded article (polymer base member), the surface of the film is the plating film-forming surface, and the electroless plating reaction is not caused at the atmospheric pressure.

In the method for forming the plating film of the present invention, the plating film, which is allowed to grow from the internal portion of the polymer member (inside portion of the surface internal portion), can be formed without roughening the surface of the polymer member. Therefore, the method for forming the plating film of the present invention is most suitable as the method for forming the plating film excellent in the adhesion performance on various types of polymer members.

In the method for forming the plating film of the present invention, when the electroless plating treatment is performed in the injection molding machine, the metal film, which has the high adhesion performance and which is excellent in the smoothness of the surface, can be formed on a such resin material having the high heat resistance. Therefore, the method for forming the plating film of the present invention is preferred as the method for manufacturing, for example, the reflector for the automobile head light in which the LED or the like is used and the high heat resistance is required.

What is claimed is:

1. A method for forming a plating film on a polymer member by using an electroless plating solution, the method comprising:
preparing a polymer member containing a metal substance, in an internal portion of the polymer member, which serves as plating catalyst cores, the polymer member having an inactive surface which is inactive to the electroless plating solution at an atmospheric pressure;
adding pressurized carbon dioxide to the electroless plating solution; and
forming the plating film on the inactive surface of the polymer member by bringing the polymer member in contact with the electroless plating solution to which the pressurized carbon dioxide has been added.

2. A method for forming a plating film on a polymer member by using an electroless plating solution, the method comprising:
preparing a polymer member having a surface outermost portion and an inside portion, and a metal substance, which is impregnated in the surface outermost portion and the inside portion, the metal substance serving as plating catalyst cores and being contained higher in the inside portion than in the surface outermost portion;
adding pressurized carbon dioxide to the electroless plating solution; and
forming the plating film on the surface outermost portion of the polymer member by bringing the polymer member in contact with the electroless plating solution to which the pressurized carbon dioxide has been added.

3. The method for forming the plating film according to claim 1, wherein the metal substance includes any one of metallic fine particles, a metal complex, and a modified material of the metal complex.

4. The method for forming the plating film according to claim 2, wherein the metal substance includes any one of metallic fine particles, a metal complex, and a modified material of the metal complex.

5. The method for forming the plating film according to claim 1, wherein the preparation of the polymer member includes:
introducing, in a molding machine, the pressurized carbon dioxide in which the metal substance is dissolved into a melted resin for forming the polymer member; and
molding the melted resin into which the metal substance has been introduced.

6. The method for forming the plating film according to claim 2, wherein the preparation of the polymer member includes:
introducing, in a molding machine, the pressurized carbon dioxide in which the metal substance has been dissolved into a melted resin for forming the polymer member; and
molding the melted resin into which the metal substance has been introduced.

7. The method for forming the plating film according to claim 1, wherein the electroless plating solution contains alcohol.

8. The method for forming the plating film according to claim 1, wherein the plating film is a nickel-phosphorus film.

9. The method for forming the plating film according to claim 1, wherein the pressurized carbon dioxide is supercritical carbon dioxide having a pressure of 7.38 to 20 MPa.

10. The method for forming the plating film according to claim 1, wherein the polymer member is prepared such that an elutable substance exists in the internal portion of the surface of the polymer member, the elutable substance being dissolvable in the electroless plating solution to which the pressurized carbon dioxide has been added.

11. The method for forming the plating film according to claim 2, wherein the polymer member is prepared such that an elutable substance exists in the internal portion of the surface of the polymer member, the elutable substance being dissolvable in the electroless plating solution to which the pressurized carbon dioxide has been added.

12. The method for forming the plating film according to claim 10, wherein the elutable substance is a mineral.

13. The method for forming the plating film according to claim 1, wherein the formation of the plating film on the surface of the polymer member comprises:
using a treatment container including a container body made of a metal, and an inner container arranged in the container body and formed of a material inactive to the electroless plating solution to which the pressurized carbon dioxide has been added; and
bringing, in the inner container, the polymer member into contact with the electroless plating solution to which the pressurized carbon dioxide has been added.

14. The method for forming the plating film according to claim 2, wherein the formation of the plating film on the polymer member comprises:
using a treatment container including a container body made of a metal, and an inner container arranged in the container body and formed of a material inactive to the electroless plating solution to which the pressurized carbon dioxide has been added; and
bringing, in the inner container, the polymer member into contact with the electroless plating solution to which the pressurized carbon dioxide has been added.

15. The method for forming the plating film according to claim 13, wherein the material forming the inner container is polytetrafluoroethylene.

16. A polymer member on which a plating film is to be formed with an electroless plating solution, the polymer member comprising:
a polymer base material having an internal portion and a metal substance, which is impregnated in the internal portion and which serves as plating catalyst cores; and
an inactive surface of the polymer base material, on which the plating film is to be formed, is inactive to the electroless plating solution at an atmospheric pressure.

17. A polymer member on which a plating film is to be formed with an electroless plating solution, the polymer member comprising:
a polymer base material which includes a surface outermost portion and an inside portion, and a metal substance, which is impregnated in the surface outermost portion and the inside portion which serves as plating catalyst cores,
wherein the metal substance is contained higher in the inside portion than in the surface outermost portion.

18. The polymer member according to claim 16, wherein an elutable substance further exists in the surface internal portion of the polymer base material, the elutable substance being dissolvable by the electroless plating solution to which with pressurized carbon dioxide has been added.

19. The polymer member according to claim 17, wherein an elutable substance further exists in the surface internal portion of the polymer base material, the elutable substance being dissolvable by the electroless plating solution to which pressurized carbon dioxide has been added.

20. The polymer member according to claim 18, wherein the elutable substance is a mineral.

21. The polymer member according to claim 16, further comprising the plating film formed on the polymer base material.

22. The polymer member according to claim 17, further comprising the plating film formed on the polymer base material.

23. The polymer member according to claim 21, wherein the plating film includes nickel.

24. The polymer member according to claim 23, wherein the metal substance includes palladium.

25. A method for producing the polymer member as defined in claim 16 by using a molding machine, the method comprising:
introducing, in the molding machine, pressurized carbon dioxide in which the metal substance is dissolved into a melted resin for forming the polymer member; and
molding the melted resin into which the metal substance has been introduced.

26. A method for producing the polymer member as defined in claim 17 by using a molding machine, the method comprising:
introducing, in the molding machine, pressurized carbon dioxide in which the metal substance is dissolved into a melted resin for forming the polymer member; and
molding the melted resin into which the metal substance has been introduced.
